(19) United States
(12) Patent Application Publication
(10) Pub. No.: US 2006/0019116 A1
(43) Pub. Date: Jan. 26, 2006

(54) White electroluminescent device with anthracene derivative host

(75) Inventors: Scott R. Conley, Rochester, NY (US); Tukaram K. Hatwar, Penfield, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/897,357

(22) Filed: Jul. 22, 2004

(51) Int. Cl. H05B 33/14

(52) U.S. Cl. 428/690; 428/917; 428/212; 313/504; 313/506; 313/112; 257/98; 257/89; 257/E51.022

(57) ABSTRACT

An OLED device for emitting white light comprises adjacent layers 1 and 2 wherein layer 1 contains a host and a yellow, orange, or red emitter and layer 2 contains a host and a blue or blue-green light emitter wherein the host in layer 2 comprises an anthracene material bearing an aromatic ring bonded to the 2-, 9-, and 10-positions of the anthracene nucleus.

### CROSS REFERENCE TO RELATED APPLICATIONS

Reference is made to commonly assigned U.S. patent application Ser. No. 10/809,064, filed Mar. 25, 2004 by Scott R. Conley et al., entitled “Electroluminescent Device With Anthracene Derivative Host”; U.S. patent application Ser. No. 10/780,436 filed Feb. 17, 2004 by Michele Ricks et al., entitled “White Light Electroluminescent Device With Stabilized Anthracene Derivative Host Having Ranges of Dopants”; U.S. patent application Ser. No. 10/801,997, filed Mar. 16, 2004 by William J. Begley et al., entitled “White Organic Light-Emitting Devices With Improved Performance”.

### FIELD OF INVENTION

This invention relates to organic electroluminescent (EL) devices comprising two layers matched to provide desired hue, typically white, and a light-emitting material where the host comprises a particular anthracene compound with good operational stability.

### BACKGROUND OF THE INVENTION

While organic electroluminescent (EL) devices have been known for over two decades, their performance limitations have represented a barrier to many desirable applications. In simplest form, an organic EL device is comprised of an anode for hole injection, a cathode for electron injection, and an organic medium sandwiched between these electrodes to support charge recombination that yields emission of light. These devices are also commonly referred to as organic light-emitting diodes, or OLEDs. Representative of earlier organic EL devices are Gurnee et al. U.S. Pat. No. 3,172,862, issued Mar. 9, 1965; Gurnee U.S. Pat. No. 3,173,050, issued Mar. 9, 1965; Dresner, “Double Injection Electroluminescence in Anthracene”, RCA Review, 30, 322-334, (1969); and Dresner U.S. Pat. No. 3,710,167, issued Jan. 9, 1973. The organic layers in these devices, usually composed of a polycyclic aromatic hydrocarbon, were very thick (much greater than 1 μm). Consequently, operating voltages were very high, often greater than 100V.

More recent organic EL devices include an organic EL element consisting of extremely thin layers (e.g., less than 1.0 μM) between the anode and the cathode. Herein, the term “organic EL element” encompasses the layers between the anode and cathode. Reducing the thickness lowered the resistance of the organic layer and has enabled devices that operate at much lower voltage. In a basic two-layer EL device structure, described first in U.S. Pat. No. 4,356,429, one organic layer of the EL element adjacent to the anode is specifically chosen to transport holes, and therefore, it is referred to as the hole-transporting layer, and the other organic layer is specifically chosen to transport electrons, and is referred to as the electron-transporting layer. Recombination of the injected holes and electrons within the organic EL element results in efficient electroluminescence.

There have also been proposed three-layer organic EL devices that contain an organic light-emitting layer (LEL) between the hole-transporting layer and electron-transporting layer, such as that disclosed by Tang et al (J. Applied Physics, 65, Pages 3610-3616, (1989)). The light-emitting layer commonly consists of a host material doped with a guest material, also known as a dopant. Still further, there has been proposed in U.S. Pat. No. 4,769,292 a four-layer EL element comprising a hole-injecting layer (HIL), a hole-transporting layer (HTL), a light-emitting layer (LEL) and an electron transport/injection layer (ETL). These structures have resulted in improved device efficiency.

Since these early inventions, further improvements in device materials have resulted in improved performance in attributes such as color, stability, luminance efficiency and manufacturability, e.g., as disclosed in U.S. Pat. No. 5,061,569, U.S. Pat. No. 5,409,783, U.S. Pat. No. 5,554,450, U.S. Pat. No. 5,593,788, U.S. Pat. No. 5,683,823, U.S. Pat. No. 5,908,581, U.S. Pat. No. 5,928,802, U.S. Pat. No. 6,020,078, and U.S. Pat. No. 6,208,077, amongst others.

Anthracene based hosts are often used in EL devices. A useful class of 9,10-di-(2-naphthyl)anthracene hosts has been disclosed in U.S. Pat. No. 5,935,721. Bis-anthracene compounds used in the luminescent layer with an improved device half-life have been disclosed in U.S. Pat. No. 6,534,199 and U.S. 2002/0136922. Electroluminescent devices with improved luminance using anthracene compound have been disclosed in U.S. Pat. No. 6,582,837. Anthracenes have also been used in the HTL as disclosed in U.S. Pat. No. 6,465,115. In addition there are other disclosures of using anthracene materials in EL devices, U.S. Pat. No. 5,972,247, JP 2001/097897, JP 2000/273056, U.S. 2002/0048687, WO 2003/060956, WO 2002/088274, WO 2003/087023 EP 0429821, WO 2003/007658, JP 2000/053677, and JP 2001/335516.

K. Kim and coworkers (U.S. 2004/0023060) describe double spiro anthracene derivatives. Among the materials reported are those which have a double spiro group located in the 2-positions of a 9,10 substituted anthracene, although materials of this nature may have a large number of carbocyclic rings and may have a high sublimation temperature.

S Yoon and coworkers, WO 2003/060956, describe anthracene materials in which one to two imidazole groups are located in the 2 or 2,6-positions of 9,10 substituted anthracenes. JP 2004/059535 describes anthracene materials in which aryl and heteroaryl groups are located the 2- or 2,6-positions of 9,10 substituted anthracenes. However, anthracenes substituted in such positions may be difficult and expensive to manufacture and may not provide all the desirable embodiments of a host material.

While there are many descriptions of hosts, including anthracene derivatives, in EL devices emitting colored light, because of the broad range of anthracene materials described, it is difficult for one skilled in the art of OLED device manufacture to choose a specific set of materials providing improved operational stability in a multilayer device emitting white light of desirable color purity.

### SUMMARY OF THE INVENTION

The invention provides an organic light emitting device (OLED) for emitting white light comprising adjacent layers 1 and 2 wherein layer 1 contains a host and a yellow, orange, or red emitter and layer 2 contains a host and a blue or blue-green light emitter wherein the host in layer 2 comprises an anthracene material bearing an aromatic ring bonded to the 2-, 9-, and 10-positions of the anthracene nucleus. The invention also includes the anthracene compound as well as a display, a lighting device, and a process employing the OLED.

Embodiments of the invention provide high luminance yield, have improved operational stability and a desirable hue.

### BRIEF DESCRIPTION OF THE DRAWINGS

FIG. 1 shows a schematic of a layer arrangement of a typical OLED device in which this invention may be used.

### DETAILED DESCRIPTION OF THE INVENTION

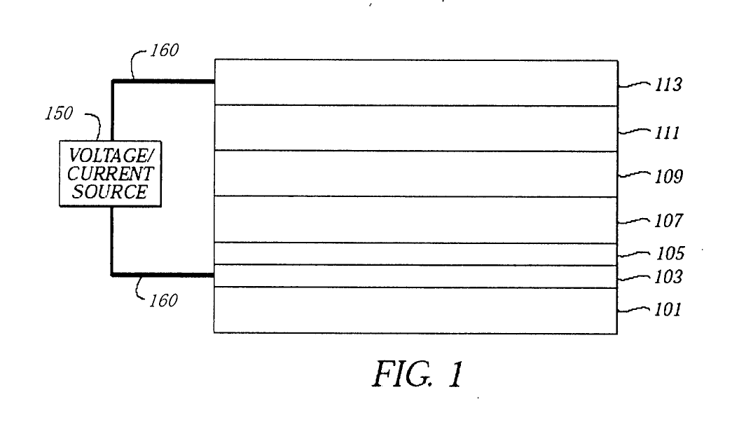

The invention is generally summarized above. In one embodiment an electroluminescent device of the invention, as shown in FIG. 1, is a multilayer device comprising a cathode, an anode, charge-injecting layers (if necessary), charge-transporting layers, and at least two light-emitting layers (LEL) comprising a host and at least one light-emitting material.

The device includes two adjacent layers matched to provide white light of desirable hue. In one embodiment one of the adjacent layers comprises a host and a yellow, orange, or red emitter and the other adjacent layer comprises a host and a blue or blue-green light emitter. The host for the yellow, orange or red emitter of the invention may be used in combination with additional host materials, which may be in the same layer or a different layer. The host materials in the yellow, orange, or red light-emitting layer can be an electron-transporting material, or a hole-transporting material, as defined below, or another material or combination of materials that support hole-electron recombination. The yellow, orange or red light-emitting materials are typically incorporated at 0.01 to 10% by weight of the host material.

A further embodiment comprises the layer emitting blue or blue-green light contains an anthracene material bearing at least one aryl ring in the 2-position, for example, a phenyl group, a naphthyl group or a biphenyl group. The anthracene material comprises up to 12 aromatic carbocyclic rings and including among the rings only carbocyclic rings. In one desirable embodiment the anthracene comprises up to 10 aromatic carbocyclic rings. The anthracene material bears an aromatic ring bonded to the 2-, 9-, and 10-positions of the anthracene nucleus including at least one naphthalene group in the 9-position of the anthracene. In one suitable embodiment the naphthalene group is a 2-naphthyl group. The 10-position of the anthracene is aryl substituted. In one embodiment the aryl substituent is a naphthyl group, such as a 2-naphthyl group or a biphenyl group, such as a 4-biphenyl group. In one desirable embodiment the 9- and 10-positions are substituted with the same naphthyl group. Suitably the anthracene material comprises only one anthracene moiety, that is, there is only one anthracene group present in the compound. In another embodiment the anthracene material comprises only two anthracene moieties, that is, there are two independently selected anthracene groups present in the comppound. The blue or blue-green emitter materials are typically incorporated at 0.01 to 10% by weight of the host material.

In one embodiment, the anthracene material is represented by Formula (1),

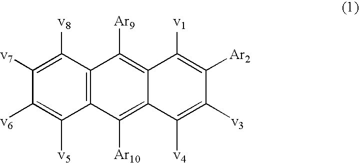

In Formula (1), Ar₂ represents an aryl group, such as a phenyl group, a naphthyl group or a biphenyl group. Ar₉ represents a naphthyl group, such as a 2-naphthyl group or a 1-naphthyl group. Ar₁₀ represents an aryl group. Examples of aryl groups are phenyl groups, tolyl groups, naphthyl groups and biphenyl groups. In Formula (1), v₁, v₃, v₄, v₅, v₆, v₇, and v₈ independently represents hydrogen or a substituent, such as a t-butyl group.

Desirably the anthracene material is in a layer that includes a light emitting material. Suitably, the anthracene material comprises the host material, there may be more than one host materials. The light-emitting material(s) is present in an amount of up to 15 vol. % of the host, commonly 0.1-10 vol. % and more typically from 0.1-5.0 vol. % of the host.

The anthracene material may also be part of an oligomer or a polymer having a main chain or a side chain of repeating units. In one useful embodiment, at least one layer of the EL device, comprises polymeric material. In another suitable embodiment, at least two layers of the EL device comprise polymeric material.

An important relationship for choosing a light-emitting fluorescent material for use with a host is a comparison of the excited singlet-state energies of the host and the fluorescent material. It is highly desirable that the excited singlet-state energy of the light-emitting material be lower than that of the host material. The excited singlet-state energy is defined as the difference in energy between the emitting singlet state and the ground state. For non-emissive hosts, the lowest excited state of the same electronic spin as the ground state is considered the emitting state.

The EL layer may emit light ranging from blue to red depending on the nature of the light-emitting material. Blue light is generally defined as having a wavelength range in the visible region of the electromagnetic spectrum of 450-480 nm, blue-green 480-510 nm, green 510-550, green-yellow 550-570 nm, yellow 570-590 nm, orange 590-630 nm and red 630-700 nm, as defined by R. W. Hunt, The Reproduction of Colour in Photography, Printing & Television, 4^{th} Edition 1987, Fountain Press. Suitable combinations of these components produce white light. When light has a spectral profile that overlaps these ranges, to whatever degree, it is loosely referred to as having both color components for example, blue-green, yellow-orange or orange-red.

Anthracene materials of the invention may be especially useful hosts for blue or blue-green materials. Many materials that emit blue or blue-green light are known in the art and are contemplated for use in the practice of the present invention. Particularly useful classes of blue emitters include perylene and its derivatives such as a perylene nucleus bearing one or more substituents such as an alkyl group or an aryl group. A desirable perylene derivative for use as an emitting material is 2,5,8,11-tetra-t-butylperylene.

Another useful class of fluorescent materials includes blue or blue-green light emitting derivatives of distyrylarenes, such as distyrylbenzene and distyrylbiphenyl, including compounds described in U.S. Pat. No. 5,121,029. Among derivatives of distyrylarenes that provide blue or blue-green luminescence, particularly useful are those substituted with diarylamino groups, also known as distyrylamines. Examples include Formula 2a and 2b, listed below, wherein R^{a}-R^{h} can be the same or different, and individually represent hydrogen or one or more substituents. For example, substituents can be alkyl groups, such as methyl groups, or aryl groups, such as phenyl groups.

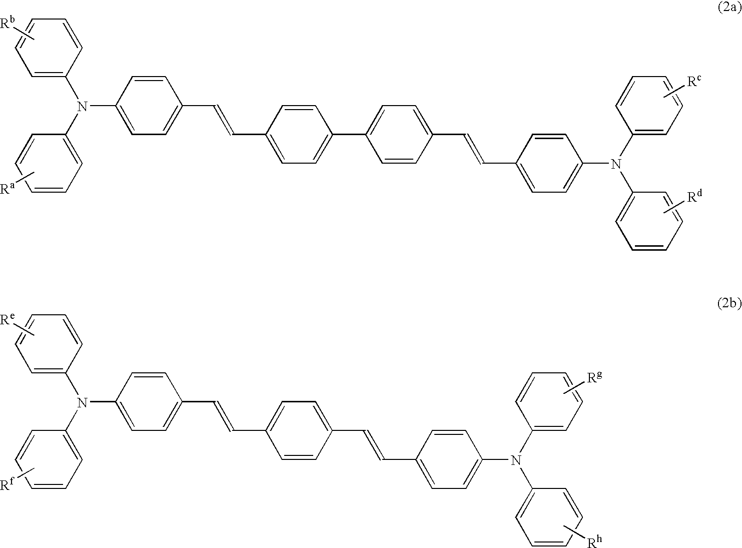

Illustrative examples of useful distyrylamines are blue or blue green emitters, (2c) and (2d) listed below.

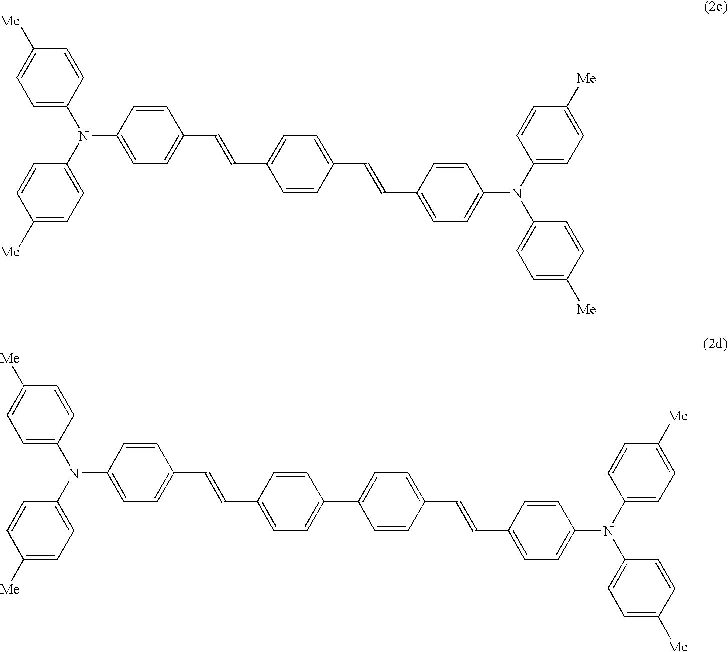

Another useful class of blue or blue green emitters comprise a boron atom. Desirable light-emitting materials that contain boron include those described in U.S. 2003/0198829 and U.S. 2003/0201415. Suitable blue or blue-green light-emitting materials are represented by the structure Formula (3a).

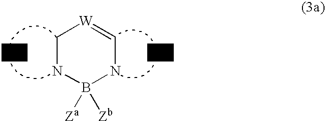

In Formula (3a), Ar^{a} and Ar^{b} independently represent the atoms necessary to form a five or six-membered aromatic ring group, such as a pyridine group. Z^{a} and Z^{b} represent independently selected substituents, such as fluoro substituents. In Formula (3a), w represents N or C—Y, wherein Y represents hydrogen or a substituent, such as an aromatic group, such as a phenyl group or a tolyl group, an alkyl group, such as a methyl group, a cyano substituent, or a trifluoromethyl substituent.

Illustrative examples of useful boron-containing fluorescent materials are listed below.

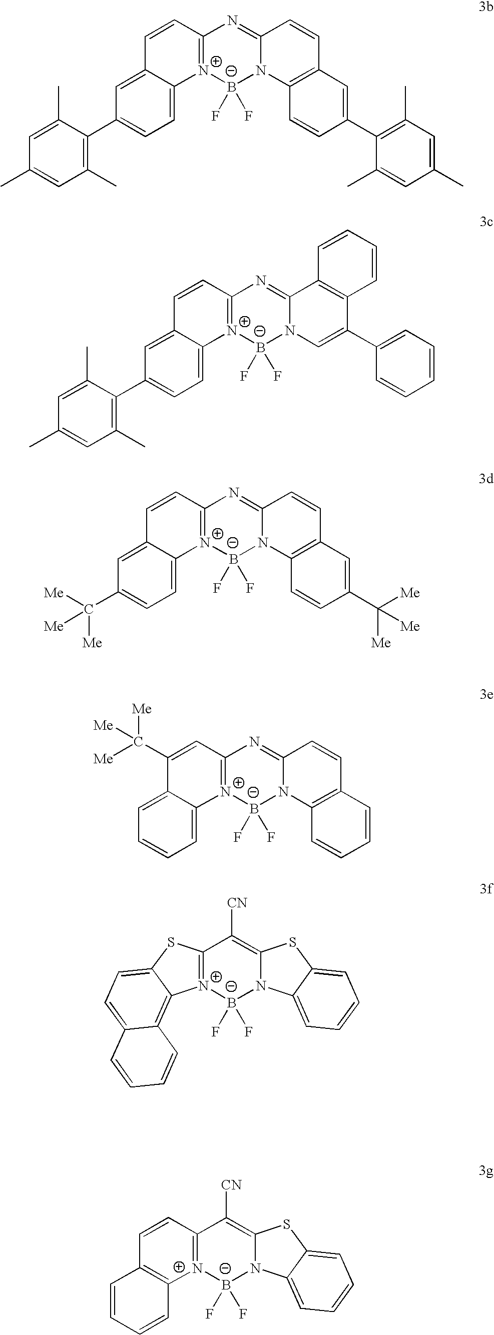

A particularly useful class of green light-emitting material includes quinacridone compounds. Useful quinacridones are described U.S. 2004/0001969, U.S. Pat. No. 6,664,396, U.S. Pat. No. 5,593,788, and JP 09-13026. In one embodiment, the light-emitting material in the light-emitting layer is a quinacridone compound represented by Formula (4).

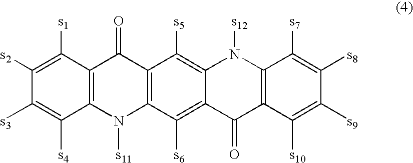

In Formula (4), s₁-s₁₀ independently represent hydrogen or an independently selected substituent, such as a phenyl group, a tolyl group, a halogen such as F, or an alkyl group, such as a methyl group. Adjacent substituents may combine to form rings, such as fused benzene ring groups.

In Formula (4), s₁₁ and s₁₂ independently represent an alkyl group or an aromatic group. In one suitable embodiment, s₁₁ and s₁₂ independently represent a phenyl ring group, such as a phenyl ring or a tolyl ring.

Illustrative examples of useful quinacridone compounds are shown below.

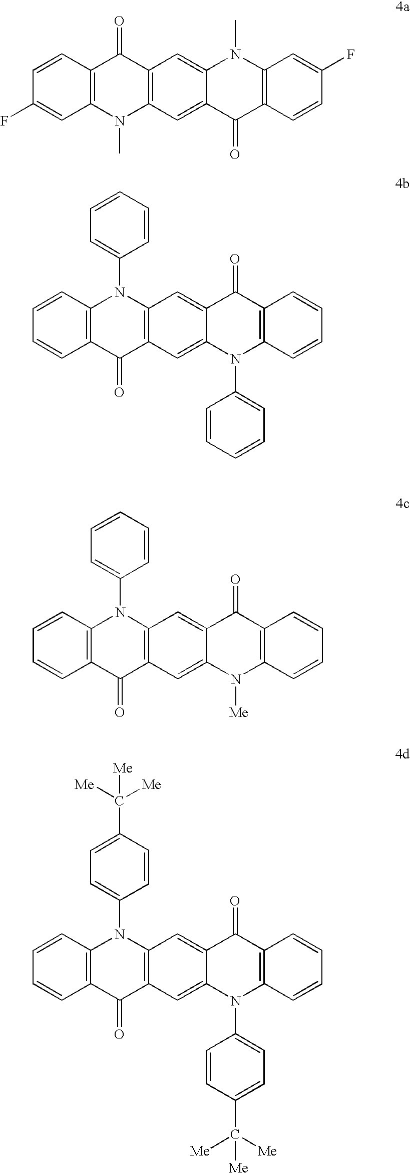

Another particularly useful class of green light-emitting materials includes coumarin compounds. For example, useful coumarins are described in Tang et al., U.S. Pat. No. 4,769,292 and U.S. Pat. No. 6,020,078. In one embodiment of the invention, the third material in the light-emitting layer is a coumarin represented by Formula (5).

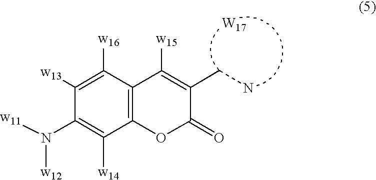

In Formula (5), w₁₁ and w₁₂ represent an independently selected substituent, such as an alkyl group or aryl group, provided w₁₁ and w₁₂ may combine with each other or with w₁₃ and w₁₄ to form rings. Desirably w₁₁ and w₁₂ represent independently selected alkyl groups, provided w₁₁ and w₁₂ may combine with each other or with w₁₃ and w₁₄ to form saturated rings. In Formula (5), w₁₃-w₁₆ independently represent hydrogen or an independently selected substituent, such as phenyl ring group or a methyl group. Adjacent substituents may combine to form rings, such as fused benzene rings. In Formula (5), w₁₇ represents the atoms necessary to complete a heteroaromatic ring, such as a benzothiazole ring group. Illustrative examples of useful coumarin compounds are shown below.

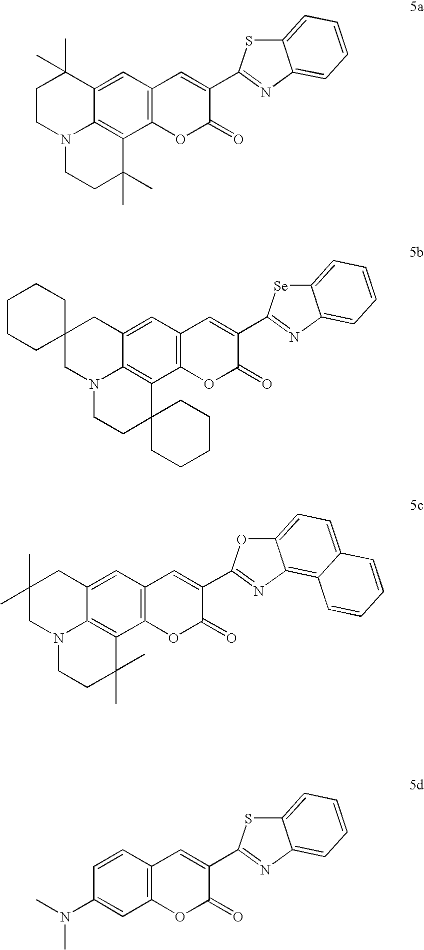

Examples of additional useful emitting materials include derivatives of anthracene, fluorene, periflanthene, and indenoperylene.

Anthracenes employed in the invention are useful in EL devices that exhibit high efficiencies and good operating stability. These compounds are useful in EL devices that produce white light as well as in full color EL devices and motion imaging devices.

In one desirable embodiment, the device of the invention has more than one layer that emits light. Suitably the device produces white light. Desirably, one layer of the device contains rubrene or a derivative of rubrene.

Useful anthracene materials may be made by various methods. For example, by the method shown in the reaction steps Rx-A through Rx-C. Reaction of a bromo-aryl compound (Ar¹Br) with a lithium reagent, for example t-butyllithium, forms the aryl-lithium salt, which then can react with compound E-1, to form E-2 (Rx-A). Dehydration of E-2 and aromatization with, for example, KI, NaH₂PO₂, and acetic acid, affords the anthracene E-3 (Rx-B). Reaction of this anthracene with an aryl boronic acid (Ar²—B(OH)₂) under Suzuki-type coupling conditions, for example, with tris(dibenzylideneacetone)dipalladium, tricyclohexylphosphine, and potassium phosphate base, affords the desired anthracene material, E-4 (Rx-C). See J. Hassan, M. Sevignon, C. Gozzi, E. Schulz, M. Lemaire, Marc, Chem. Rev, 102, 1359 (2002) and references cited therein for a review of the Suzuki coupling reaction and similar reactions.

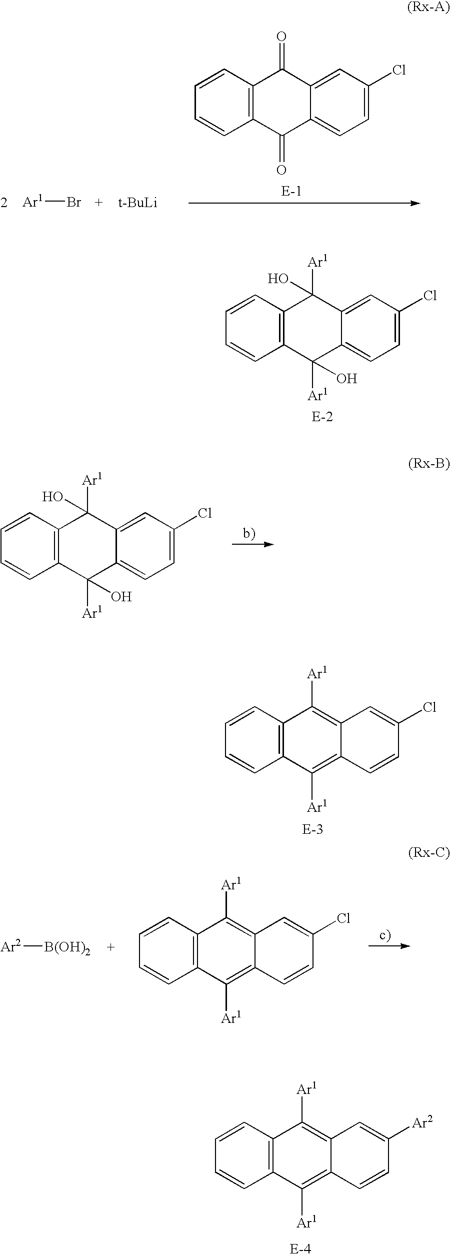

Useful compounds of this invention include:

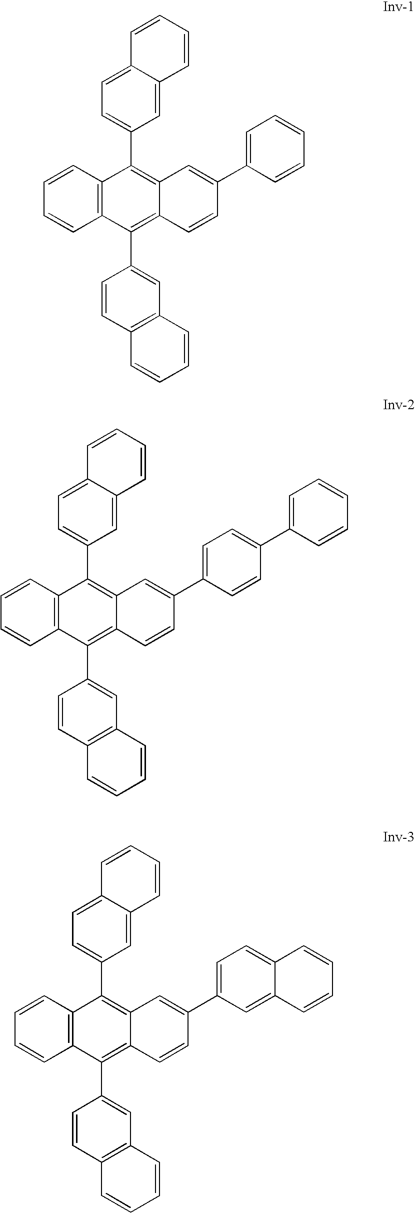

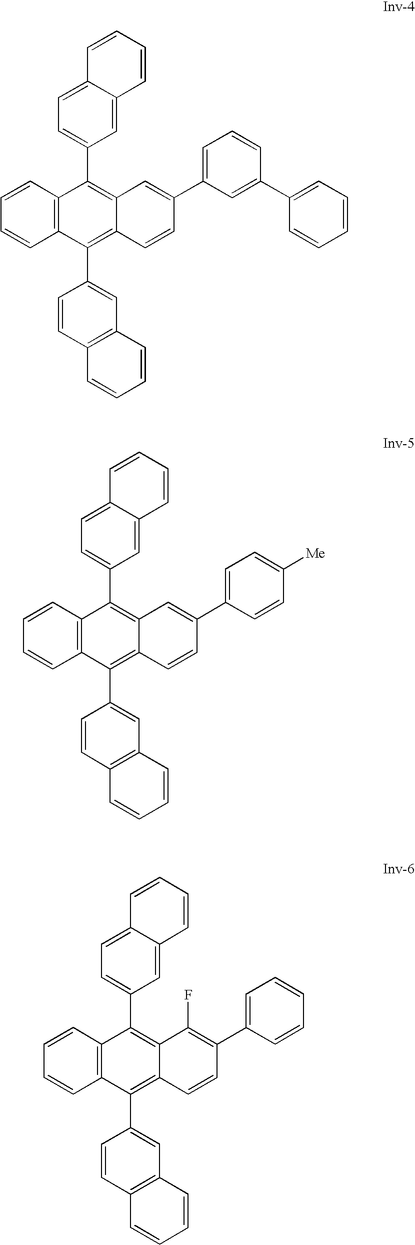

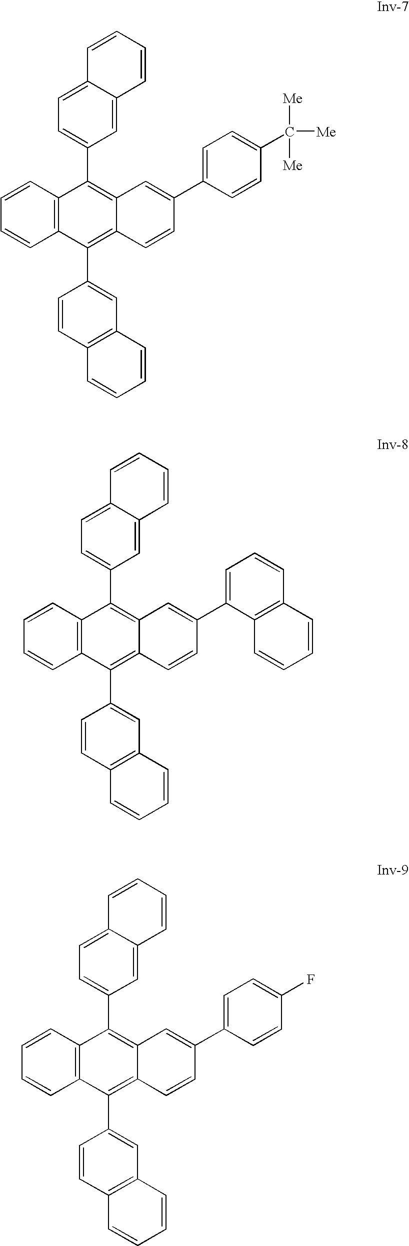

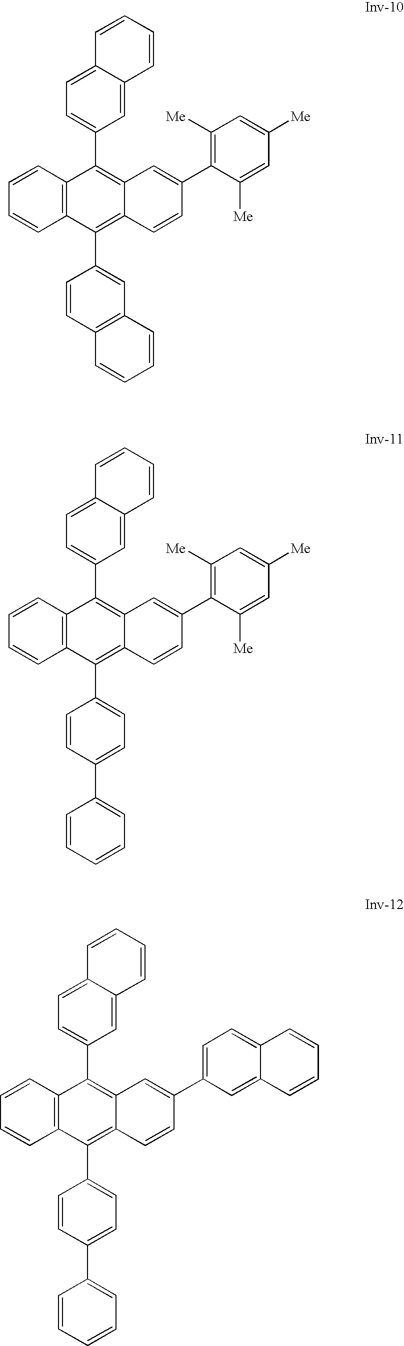

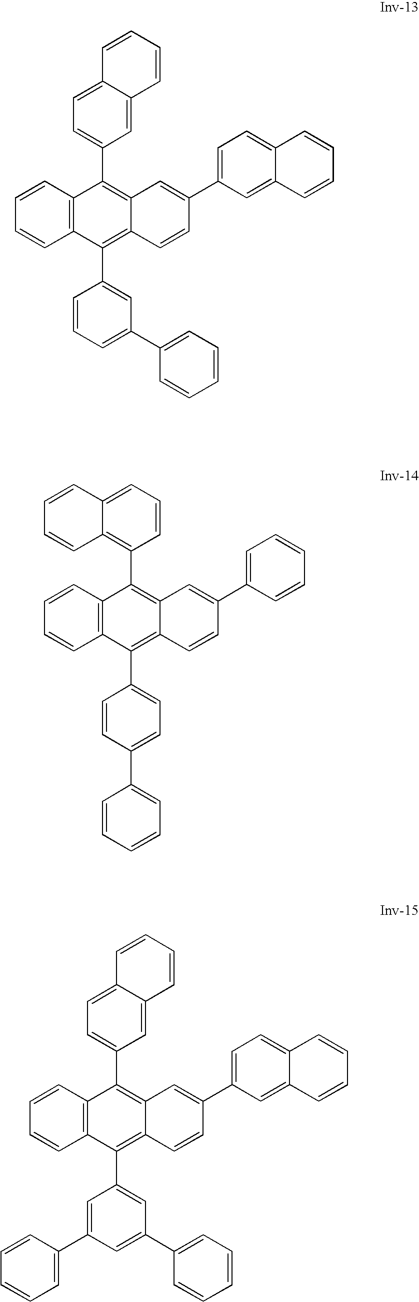

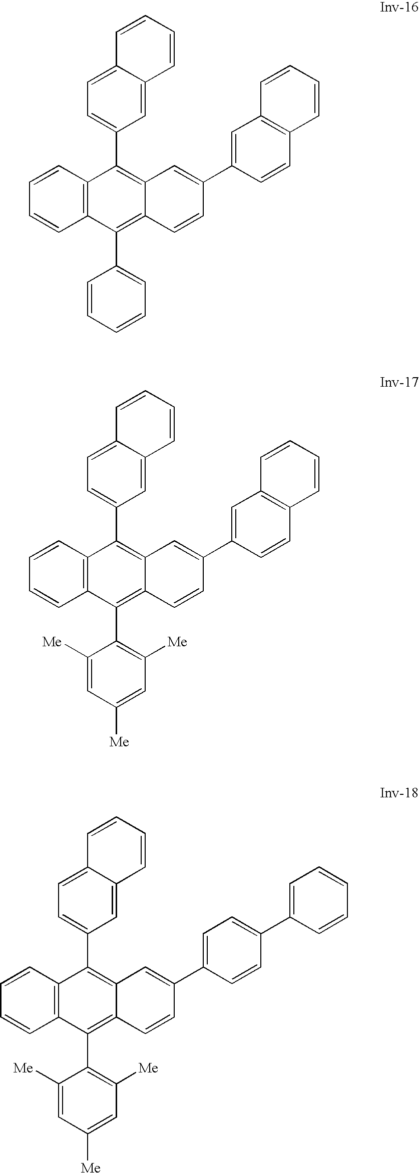

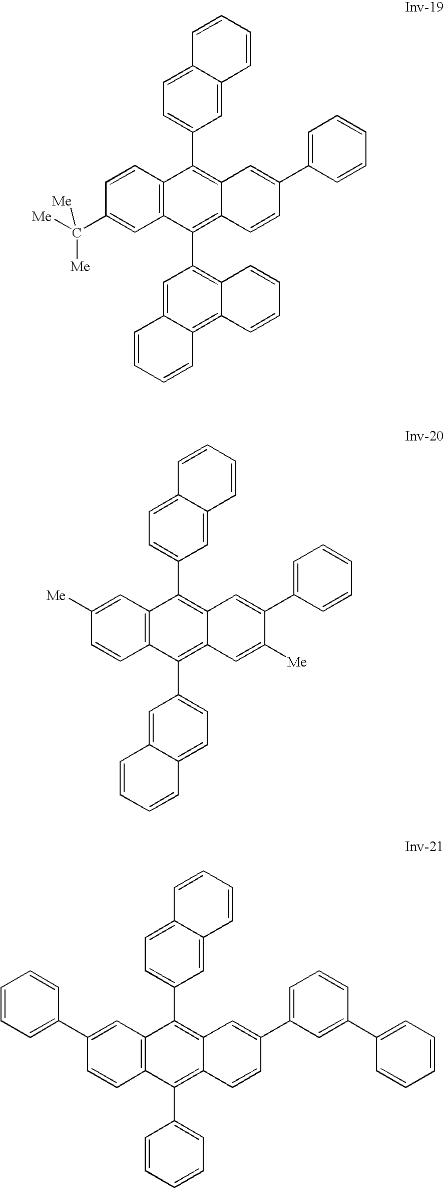

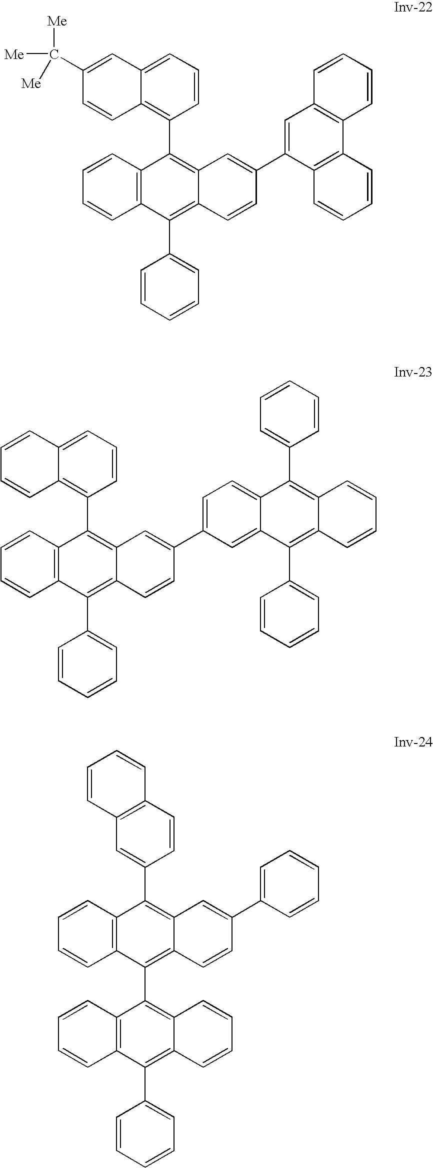

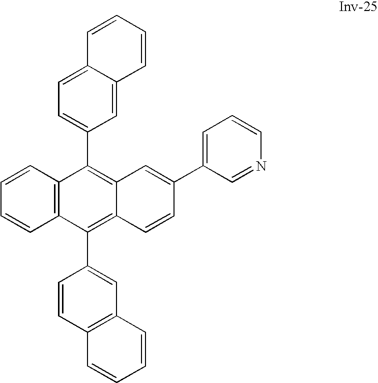

Unless otherwise specifically stated, use of the term “aryl group” or “aromatic ring” means both carbocyclic and heterocyclic groups. Additionally, use of the term “substituted” or “substituent” means any group or atom other than hydrogen. Additionally, when the term “group” or “compound” is used, it means that when a group contains a substitutable hydrogen, it is also intended to encompass not only the unsubstituted form, but also its form further substituted with any substituent group or groups as herein mentioned, so long as the substituent does not destroy properties necessary for device utility. Suitably, a substituent group may be halogen or may be bonded to the remainder of the molecule by an atom of carbon, silicon, oxygen, nitrogen, phosphorous, sulfur, selenium, or boron. The substituent may be, for example, halogen, such as chloro, bromo or fluoro; nitro; hydroxyl; cyano; carboxyl; or groups which may be further substituted, such as alkyl, including straight or branched chain or cyclic alkyl, such as methyl, trifluoromethyl, ethyl, t-butyl, 3-(2,4-di-t-pentylphenoxy) propyl, and tetradecyl; alkenyl, such as ethylene, 2-butene; alkoxy, such as methoxy, ethoxy, propoxy, butoxy, 2-methoxyethoxy, sec-butoxy, hexyloxy, 2-ethylhexyloxy, tetradecyloxy, 2-(2,4-di-t-pentylphenoxy)ethoxy, and 2-dodecyloxyethoxy; aryl such as phenyl, 4-t-butylphenyl, 2,4,6-trimethylphenyl, naphthyl; aryloxy, such as phenoxy, 2-methylphenoxy, alpha- or beta-naphthyloxy, and 4-tolyloxy; carbonamido, such as acetamido, benzamido, butyramido, tetradecanamido, alpha-(2,4-di-t-pentyl-phenoxy)acetamido, alpha-(2,4-di-t-pentylphenoxy)butyramido, alpha-(3-pentadecylphenoxy)-hexanamido, alpha-(4-hydroxy-3-t-butylphenoxy)-tetradecanamido, 2-oxo-pyrrolidin-1-yl, 2-oxo-5-tetradecylpyrrolin-1-yl, N-methyltetradecanamido, N-succinimido, N-phthalimido, 2,5-dioxo-1-oxazolidinyl, 3-dodecyl-2,5-dioxo-1-imidazolyl, and N-acetyl-N-dodecylamino, ethoxycarbonylamino, phenoxycarbonylamino, benzyloxycarbonylamino, hexadecyloxycarbonylamino, 2,4-di-t-butylphenoxycarbonylamino, phenylcarbonylamino, 2,5-(di-t-pentylphenyl)carbonylamino, p-dodecyl-phenylcarbonylamino, p-tolylcarbonylamino, N-methylureido, N,N-dimethylureido, N-methyl-N-dodecylureido, N-hexadecylureido, N,N-dioctadecylureido, N,N-dioctyl-N′-ethylureido, N-phenylureido, N,N-diphenylureido, N-phenyl-N-p-tolylureido, N-(m-hexadecylphenyl)ureido, N,N-(2,5-di-t-pentylphenyl)-N′-ethylureido, and t-butylcarbonamido; sulfonamido, such as methylsulfonamido, benzenesulfonamido, p-tolylsulfonamido, p-dodecylbenzenesulfonamido, N-methyltetradecylsulfonamido, N,N-dipropyl-sulfamoylamino, and hexadecylsulfonamido; sulfamoyl, such as N-methylsulfamoyl, N-ethylsulfamoyl, N,N-dipropylsulfamoyl, N-hexadecylsulfamoyl, N,N-dimethylsulfamoyl, N-[3-(dodecyloxy)propyl]sulfamoyl, N-[4-(2,4-di-t-pentylphenoxy)butyl]sulfamoyl, N-methyl-N-tetradecylsulfamoyl, and N-dodecylsulfamoyl; carbamoyl, such as N-methylcarbamoyl, N,N-dibutylcarbamoyl, N-octadecylcarbamoyl, N-[4-(2,4-di-t-pentylphenoxy)butyl]carbamoyl, N-methyl-N-tetradecylcarbamoyl, and N,N-dioctylcarbamoyl; acyl, such as acetyl, (2,4-di-t-amylphenoxy)acetyl, phenoxycarbonyl, p-dodecyloxyphenoxycarbonyl methoxycarbonyl, butoxycarbonyl, tetradecyloxycarbonyl, ethoxycarbonyl, benzyloxycarbonyl, 3-pentadecyloxycarbonyl, and dodecyloxycarbonyl; sulfonyl, such as methoxysulfonyl, octyloxysulfonyl, tetradecyloxysulfonyl, 2-ethylhexyloxysulfonyl, phenoxysulfonyl, 2,4-di-t-pentylphenoxysulfonyl, methylsulfonyl, octylsulfonyl, 2-ethylhexylsulfonyl, dodecylsulfonyl, hexadecylsulfonyl, phenylsulfonyl, 4-nonylphenylsulfonyl, and p-tolylsulfonyl; sulfonyloxy, such as dodecylsulfonyloxy, and hexadecylsulfonyloxy; sulfinyl, such as methylsulfinyl, octylsulfinyl, 2-ethylhexylsulfinyl, dodecylsulfinyl, hexadecylsulfinyl, phenylsulfinyl, 4-nonylphenylsulfinyl, and p-tolylsulfinyl; thio, such as ethylthio, octylthio, benzylthio, tetradecylthio, 2-(2,4-di-t-pentylphenoxy)ethylthio, phenylthio, 2-butoxy-5-t-octylphenylthio, and p-tolylthio; acyloxy, such as acetyloxy, benzoyloxy, octadecanoyloxy, p-dodecylamidobenzoyloxy, N-phenylcarbamoyloxy, N-ethylcarbamoyloxy, and cyclohexylcarbonyloxy; amine, such as phenylanilino, 2-chloroanilino, diethylamine, dodecylamine; imino, such as 1 (N-phenylimido)ethyl, N-succinimido or 3-benzylhydantoinyl; phosphate, such as dimethylphosphate and ethylbutylphosphate; phosphite, such as diethyl and dihexylphosphite; a heterocyclic group, a heterocyclic oxy group or a heterocyclic thio group, each of which may be substituted and which contain a 3 to 7 membered heterocyclic ring composed of carbon atoms and at least one hetero atom selected from the group consisting of oxygen, nitrogen, sulfur, phosphorous, or boron such as 2-furyl, 2-thienyl, 2-benzimidazolyloxy or 2-benzothiazolyl; quaternary ammonium, such as triethylammonium; quaternary phosphonium, such as triphenylphosphonium; and silyloxy, such as trimethylsilyloxy.

If desired, the substituents may themselves be further substituted one or more times with the described substituent groups. The particular substituents used may be selected by those skilled in the art to attain the desired desirable properties for a specific application and can include, for example, electron-withdrawing groups, electron-donating groups, and steric groups. When a molecule may have two or more substituents, the substituents may be joined together to form a ring such as a fused ring unless otherwise provided. Generally, the above groups and substituents thereof may include those having up to 48 carbon atoms, typically 1 to 36 carbon atoms and usually less than 24 carbon atoms, but greater numbers are possible depending on the particular substituents selected.

General Device Architecture

The present invention can be employed in many EL device configurations using small molecule materials, oligomeric materials, polymeric materials, or combinations thereof. These include very simple structures comprising a single anode and cathode to more complex devices, such as passive matrix displays comprised of orthogonal arrays of anodes and cathodes to form pixels, and active-matrix displays where each pixel is controlled independently, for example, with thin film transistors (TFTs).

There are numerous configurations of the organic layers wherein the present invention can be successfully practiced. The essential requirements of an OLED are an anode, a cathode, and an organic light-emitting layer located between the anode and cathode. Additional layers may be employed as more fully described hereafter.

A typical structure according to the present invention and especially useful for a small molecule device, is shown in FIG. 1 and is comprised of a substrate 101, an anode 103, a hole-injecting layer 105, a hole-transporting layer 107, a light-emitting layer 109, an electron-transporting layer 111, and a cathode 113, and a voltage source 150 with electrical conductors 160 to the anode and the cathode. These layers are described in detail below. Note that the substrate 101 may alternatively be located adjacent to the cathode 113, or the substrate 101 may actually constitute the anode 103 or cathode 113. The organic layers between the anode 103 and cathode 113 are conveniently referred to as the organic EL element. Also, the total combined thickness of the organic layers is desirably less than 500 nm. If the device includes phosphorescent material, a hole-blocking layer, located between the light-emitting layer and the electron-transporting layer, may be present.

The anode 103 and cathode 113 of the OLED are connected to a voltage/current source through electrical conductors. Applying a potential between the anode 103 and cathode 113 such that the anode 103 is at a more positive potential than the cathode 113 operates the OLED. Holes are injected into the organic EL element from the anode 103 and electrons are injected into the organic EL element at the cathode 113. Enhanced device stability can sometimes be achieved when the OLED is operated in an AC mode where, for some time period in the AC cycle, the potential bias is reversed and no current flows. An example of an AC driven OLED is described in U.S. Pat. No. 5,552,678.

Substrate

The OLED device of this invention is typically provided over a supporting substrate 101 where either the cathode 113 or anode 103 can be in contact with the substrate. The electrode in contact with the substrate 101 is conveniently referred to as the bottom electrode. Conventionally, the bottom electrode is the anode 103, but this invention is not limited to that configuration. The substrate 101 can either be light transmissive or opaque, depending on the intended direction of light emission. The light transmissive property is desirable for viewing the EL emission through the substrate 101. Transparent glass or plastic is commonly employed in such cases. The substrate 101 can be a complex structure comprising multiple layers of materials. This is typically the case for active matrix substrates wherein TFTs are provided below the OLED layers. It is still necessary that the substrate 101, at least in the emissive pixelated areas, be comprised of largely transparent materials such as glass or polymers. For applications where the EL emission is viewed through the top electrode, the transmissive characteristic of the bottom support is immaterial, and therefore the substrate can be light transmissive, light absorbing or light reflective. Substrates for use in this case include, but are not limited to, glass, plastic, semiconductor materials such as silicon, ceramics, and circuit board materials. Again, the substrate 101 can be a complex structure comprising multiple layers of materials such as found in active matrix TFT designs. It is necessary to provide in these device configurations a light-transparent top electrode.

Anode

When the desired electroluminescent light emission (EL) is viewed through the anode, the anode 103 should be transparent or substantially transparent to the emission of interest. Common transparent anode materials used in this invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode 103. For applications where EL emission is viewed only through the cathode 113, the transmissive characteristics of the anode 103 are immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means. Anodes can be patterned using well-known photolithographic processes. Optionally, anodes may be polished prior to application of other layers to reduce surface roughness so as to minimize short circuits or enhance reflectivity.

Cathode

When light emission is viewed solely through the anode 103, the cathode 113 used in this invention can be comprised of nearly any conductive material. Desirable materials have good film-forming properties to ensure good contact with the underlying organic layer, promote electron injection at low voltage, and have good stability. Useful cathode materials often contain a low work function metal (<4.0 eV) or metal alloy. One useful cathode material is comprised of a Mg:Ag alloy wherein the percentage of silver is in the range of 1 to 20%, as described in U.S. Pat. No. 4,885,221. Another suitable class of cathode materials includes bilayers comprising the cathode and a thin electron-injection layer (EIL) in contact with an organic layer (e.g., an electron transporting layer (ETL)), the cathode being capped with a thicker layer of a conductive metal. Here, the EIL preferably includes a low work function metal or metal salt, and if so, the thicker capping layer does not need to have a low work function. One such cathode is comprised of a thin layer of LiF followed by a thicker layer of Al as described in U.S. Pat. No. 5,677,572. An ETL material doped with an alkali metal, for example, Li-doped Alq, is another example of a useful EIL. Other useful cathode material sets include, but are not limited to, those disclosed in U.S. Pat. Nos. 5,059,861, 5,059,862, and 6,140,763.

When light emission is viewed through the cathode, the cathode 113 must be transparent or nearly transparent. For such applications, metals must be thin or one must use transparent conductive oxides, or a combination of these materials. Optically transparent cathodes have been described in more detail in U.S. Pat. No. 4,885,211, U.S. Pat. No. 5,247,190, JP 3,234,963, U.S. Pat. No. 5,703,436, U.S. Pat. No. 5,608,287, U.S. Pat. No. 5,837,391, U.S. Pat. No. 5,677,572, U.S. Pat. No. 5,776,622, U.S. Pat. No. 5,776,623, U.S. Pat. No. 5,714,838, U.S. Pat. No. 5,969,474, U.S. Pat. No. 5,739,545, U.S. Pat. No. 5,981,306, U.S. Pat. No. 6,137,223, U.S. Pat. No. 6,140,763, U.S. Pat. No. 6,172,459, EP 1 076 368, U.S. Pat. No. 6,278,236, and U.S. Pat. No. 6,284,3936. Cathode materials are typically deposited by any suitable method such as evaporation, sputtering, or chemical vapor deposition. When needed, patterning can be achieved through many well known methods including, but not limited to, through-mask deposition, integral shadow masking as described in U.S. Pat. No. 5,276,380 and EP 0 732 868, laser ablation, and selective chemical vapor deposition.

Hole-Injecting Layer (HIL)

A hole-injecting layer 105 may be provided between anode 103 and hole-transporting layer 107. The hole-injecting layer can serve to improve the film formation property of subsequent organic layers and to facilitate injection of holes into the hole-transporting layer 107. Suitable materials for use in the hole-injecting layer 105 include, but are not limited to, porphyrinic compounds as described in U.S. Pat. No. 4,720,432, plasma-deposited fluorocarbon polymers as described in U.S. Pat. No. 6,208,075, and some aromatic amines, for example, MTDATA (4,4′,4″-tris[(3-methylphenyl)phenylamino]triphenylamine). Alternative hole-injecting materials reportedly useful in organic EL devices are described in EP 0 891 121 A1 and EP 1 029 909 A1. A hole-injection layer is conveniently used in the present invention, and is desirably a plasma-deposited fluorocarbon polymer. The thickness of a hole-injection layer containing a plasma-deposited fluorocarbon polymer can be in the range of 0.2 nm to 15 nm and suitably in the range of 0.3 to 1.5 nm.

Hole-Transporting Layer (HTL)

While not always necessary, it is often useful to include a hole-transporting layer in an OLED device. The hole-transporting layer 107 of the organic EL device contains at least one hole-transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. U.S. Pat. No. 3,180,730. Other suitable triarylamines substituted with one or more vinyl radicals and/or comprising at least one active hydrogen containing group are disclosed by Brantley et al U.S. Pat. No. 3,567,450 and U.S. Pat. No. 3,658,520.

A more preferred class of aromatic tertiary amines is those which include at least two aromatic tertiary amine moieties as described in U.S. Pat. No. 4,720,432 and U.S. Pat. No. 5,061,569. Such compounds include those represented by structural formula (A). 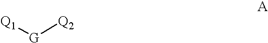
wherein Q₁ and Q₂ are independently selected aromatic tertiary amine moieties and G is a linking group such as an arylene, cycloalkylene, or alkylene group of a carbon to carbon bond. In one embodiment, at least one of Q₁ or Q₂ contains a polycyclic fused ring structure, e.g., a naphthalene. When G is an aryl group, it is conveniently a phenylene, biphenylene, or naphthalene moiety.

A useful class of triarylamines satisfying structural formula (A) and containing two triarylamine moieties is represented by structural formula (B): 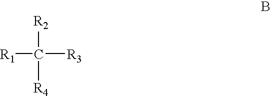
where
R₁ and R₂ each independently represents a hydrogen atom, an aryl group, or an alkyl group or R₁ and R₂ together represent the atoms completing a cycloalkyl group; and
R₃ and R₄ each independently represents an aryl group, which is in turn substituted with a diaryl substituted amino group, as indicated by structural formula (C): 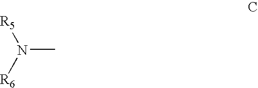
   wherein R₅ and R₆ are independently selected aryl groups. In one embodiment, at least one of R₅ or R₆ contains a polycyclic fused ring structure, e.g., a naphthalene.

Another class of aromatic tertiary amines is the tetraaryldiamines. Desirable tetraaryldiamines include two diarylamino groups, such as indicated by formula (C), linked through an arylene group. Useful tetraaryldiamines include those represented by formula (D). 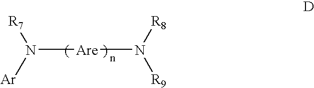
wherein
each Are is an independently selected arylene group, such as a phenylene or anthracene moiety,
n is an integer of from 1 to 4, and
Ar, R₇, R₈, and R₉ are independently selected aryl groups.

In a typical embodiment, at least one of Ar, R₇, R₈, and R₉ is a polycyclic fused ring structure, e.g., a naphthalene.

The various alkyl, alkylene, aryl, and arylene moieties of the foregoing structural formulae (A), (B), (C), (D), can each in turn be substituted. Typical substituents include alkyl groups, alkoxy groups, aryl groups, aryloxy groups, and halide such as fluoride, chloride, and bromide. The various alkyl and alkylene moieties typically contain from about 1 to 6 carbon atoms. The cycloalkyl moieties can contain from 3 to about 10 carbon atoms, but typically contain five, six, or seven ring carbon atoms—e.g., cyclopentyl, cyclohexyl, and cycloheptyl ring structures. The aryl and arylene moieties are usually phenyl and phenylene moieties.

The hole-transporting layer can be formed of a single tertiary amine compound or a mixture of such compounds. Specifically, one may employ a triarylamine, such as a triarylamine satisfying the formula (B), in combination with a tetraaryldiamine, such as indicated by formula (D). Illustrative of useful aromatic tertiary amines are the following:
1,1-Bis(4-di-p-tolylaminophenyl)cyclohexane (TAPC)
1,1-Bis(4-di-p-tolylaminophenyl)-4-methylcyclohexane
1,1-Bis(4-di-p-tolylaminophenyl)-4-phenylcyclohexane
1,1-Bis(4-di-p-tolylaminophenyl)-3-phenylpropane (TAPPP)
N,N,N′,N′-tetraphenyl-4,4′″-diamino-1,1′:4′,1″:4″,1′″-quaterphenyl
Bis(4-dimethylamino-2-methylphenyl)phenylmethane
1,4-bis[2-[4-[N,N-di(p-toly)amino]phenyl]vinyl]benzene (BDTAPVB)
N,N,N′,N′-Tetra-p-tolyl-4,4′-diaminobiphenyl (TTB)
N,N,N′,N′-Tetraphenyl-4,4′-diaminobiphenyl
N,N,N′,N′-tetra-1-naphthyl-4,4′-diaminobiphenyl
N,N,N′,N′-tetra-2-naphthyl-4,4′-diaminobiphenyl
N-Phenylcarbazole
4,4′-Bis[N-(1-naphthyl)-N-phenylamino]biphenyl (NPB)
4,4′-Bis[N-(1-naphthyl)-N-(2-naphthyl)amino]biphenyl (TNB)
4,4′-Bis[N-(1-naphthyl)-N-phenylamino]p-terphenyl
4,4′-Bis[N-(2-naphthyl)-N-phenylamino]biphenyl
4,4′-Bis[N-(3-acenaphthenyl)-N-phenylamino]biphenyl
1,5-Bis[N-(1-naphthyl)-N-phenylamino]naphthalene
4,4′-Bis[N-(9-anthryl)-N-phenylamino]biphenyl
4,4′-Bis[N-(1-anthryl)-N-phenylamino]-p-terphenyl
4,4′-Bis[N-(2-phenanthryl)-N-phenylamino]biphenyl
4,4′-Bis[N-(8-fluoranthenyl)-N-phenylamino]biphenyl
4,4′-Bis[N-(2-pyrenyl)-N-phenylamino]biphenyl
4,4′-Bis[N-(2-naphthacenyl)-N-phenylamino]biphenyl
4,4′-Bis[N-(2-perylenyl)-N-phenylamino]biphenyl
4,4′-Bis[N-(1-coronenyl)-N-phenylamino]biphenyl
2,6-Bis(di-p-tolylamino)naphthalene
2,6-Bis[di-(1-naphthyl)amino]naphthalene
2,6-Bis[N-(1-naphthyl)-N-(2-naphthyl)amino]naphthalene
N,N,N′,N′-Tetra(2-naphthyl)-4,4″-diamino-p-terphenyl
4,4′-Bis {N-phenyl-N-[4-(1-naphthyl)-phenyl]amino}biphenyl
2,6-Bis[N,N-di(2-naphthyl)amino]fluorene
4,4′,4″-tris[(3-methylphenyl)phenylamino]triphenylamine (MTDATA)
4,4′-Bis[N-(3-methylphenyl)-N-phenylamino]biphenyl (TPD)

Another class of useful hole-transporting materials includes polycyclic aromatic compounds as described in EP 1 009 041. Tertiary aromatic amines with more than two amine groups may be used including oligomeric materials. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS. It is also possible for the hole-transporting layer to comprise two or more sublayers of differing compositions, the composition of each sublayer being as described above. The thickness of the hole-transporting layer can be between 10 and about 500 nm and suitably between 50 and 300 nm.

Light-Emitting Layer (LEL)

Light emitting materials useful in the EL device include fluorescent materials. As more fully described in U.S. Pat. Nos. 4,769,292 and 5,935,721, the light-emitting layer (LEL) of the organic EL element includes a luminescent material where electroluminescence is produced as a result of electron-hole pair recombination. The light-emitting layer can be comprised of a single material, but more commonly consists of a host material doped with a guest emitting material or materials where light emission comes primarily from the emitting materials and can be of any color.

The host materials of the invention may be used in combination with additional host materials, which may be in the same layer or a different layer. The host materials in the light-emitting layer can be an electron-transporting material, as defined below, a hole-transporting material, as defined above, or another material or combination of materials that support hole-electron recombination. Fluorescent emitting materials are typically incorporated at 0.01 to 10% by weight of the host material.

The host and emitting materials can be small non-polymeric molecules or polymeric materials such as polyfluorenes and polyvinylarylenes (e.g., poly(p-phenylenevinylene), PPV). In the case of polymers, small-molecule emitting materials can be molecularly dispersed into a polymeric host, or the emitting materials can be added by copolymerizing a minor constituent into a host polymer. Host materials may be mixed together in order to improve film formation, electrical properties, light emission efficiency, operating lifetime, or manufacturability. The host may comprise a material that has good hole-transporting properties and a material that has good electron-transporting properties.

An important relationship for choosing a fluorescent material as a guest emitting material is a comparison of the excited singlet-state energies of the host and the fluorescent material. It is highly desirable that the excited singlet-state energy of the fluorescent material be lower than that of the host material. The excited singlet-state energy is defined as the difference in energy between the emitting singlet state and the ground state. For non-emissive hosts, the lowest excited state of the same electronic spin as the ground state is considered the emitting state.

Host and emitting materials known to be of use include, but are not limited to, those disclosed in U.S. Pat. No. 4,768,292, U.S. Pat. No. 5,141,671, U.S. Pat. No. 5,150,006, U.S. Pat. No. 5,151,629, U.S. Pat. No. 5,405,709, U.S. Pat. No. 5,484,922, U.S. Pat. No. 5,593,788, U.S. Pat. No. 5,645,948, U.S. Pat. No. 5,683,823, U.S. Pat. No. 5,755,999, U.S. Pat. No. 5,928,802, U.S. Pat. No. 5,935,720, U.S. Pat. No. 5,935,721, and U.S. Pat. No. 6,020,078.

Metal complexes of 8-hydroxyquinoline and similar derivatives, also known as metal-chelated oxinoid compounds (Formula E), constitute one class of useful host compounds capable of supporting electroluminescence, and are particularly suitable for light emission of wavelengths longer than 500 nm, e.g., green, yellow, orange, and red. 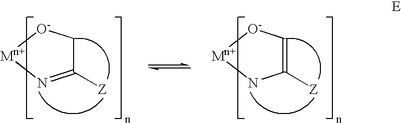
wherein
M represents a metal;
n is an integer of from 1 to 4; and
Z independently in each occurrence represents the atoms completing a nucleus having at least two fused aromatic rings.

From the foregoing it is apparent that the metal can be monovalent, divalent, trivalent, or tetravalent metal. The metal can, for example, be an alkali metal, such as lithium, sodium, or potassium; an alkaline earth metal, such as magnesium or calcium; a trivalent metal, such aluminum or gallium, or another metal such as zinc or zirconium. Generally any monovalent, divalent, trivalent, or tetravalent metal known to be a useful chelating metal can be employed.

Z completes a heterocyclic nucleus containing at least two fused aromatic rings, at least one of which is an azole or azine ring. Additional rings, including both aliphatic and aromatic rings, can be fused with the two required rings, if required. To avoid adding molecular bulk without improving on function the number of ring atoms is usually maintained at 18 or less.

Illustrative of useful chelated oxinoid compounds are the following:
CO-1: Aluminum trisoxine [alias, tris(8-quinolinolato)aluminum(III)]
CO-2: Magnesium bisoxine [alias, bis(8-quinolinolato)magnesium(II)]
CO-3: Bis[benzo {f}-8-quinolinolato]zinc (II)
CO-4: Bis(2-methyl-8-quinolinolato)aluminum(III)-μ-oxo-bis(2-methyl-8-quinolinolato) aluminum(III)
CO-5: Indium trisoxine [alias, tris(8-quinolinolato)indium]
CO-6: Aluminum tris(5-methyloxine) [alias, tris(5-methyl-8-quinolinolato) aluminum(III)]
CO-7: Lithium oxine [alias, (8-quinolinolato)lithium(I)]
CO-8: Gallium oxine [alias, tris(8-quinolinolato)gallium(III)]
CO-9: Zirconium oxine [alias, tetra(8-quinolinolato)zirconium(IV)]

Derivatives of 9,10-di-(2-naphthyl)anthracene (Formula F) constitute one class of useful host materials capable of supporting electroluminescence, and are particularly suitable for light emission of wavelengths longer than 400 nm, e.g., blue, green, yellow, orange or red. 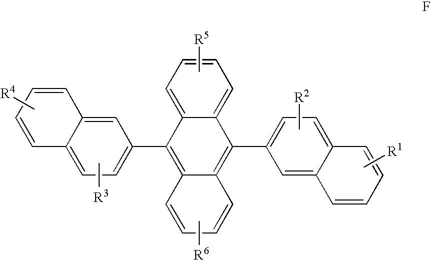
wherein: R¹, R², R³, R⁴, R⁵, and R⁶ represent one or more substituents on each ring where each substituent is individually selected from the following groups:
Group 1: hydrogen, or alkyl of from 1 to 24 carbon atoms;
Group 2: aryl or substituted aryl of from 5 to 20 carbon atoms;
Group 3: carbon atoms from 4 to 24 necessary to complete a fused aromatic ring of anthracenyl; pyrenyl, or perylenyl;
Group 4: heteroaryl or substituted heteroaryl of from 5 to 24 carbon atoms as necessary to complete a fused heteroaromatic ring of furyl, thienyl, pyridyl, quinolinyl or other heterocyclic systems;
Group 5: alkoxyl amino, alkylamino, or arylamino of from 1 to 24 carbon atoms; and
Group 6: fluorine, chlorine, bromine or cyano.

Illustrative examples include 9,10-di-(2-naphthyl)anthracene and 2-t-butyl-9,10-di-(2-naphthyl)anthracene. Other anthracene derivatives can be useful as a host in the LEL, including derivatives of 9,10-bis[4-(2,2-diphenylethenyl)phenyl]anthracene.

Benzazole derivatives (Formula G) constitute another class of useful host materials capable of supporting electroluminescence, and are particularly suitable for light emission of wavelengths longer than 400 nm, e.g., blue, green, yellow, orange or red. 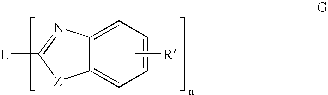
wherein:
n is an integer of 3 to 8;
Z is O, NR or S; and
R and R′ are individually hydrogen; alkyl of from 1 to 24 carbon atoms, for example, propyl, t-butyl, heptyl, and the like; aryl or hetero-atom substituted aryl of from 5 to 20 carbon atoms for example phenyl and naphthyl, furyl, thienyl, pyridyl, quinolinyl and other heterocyclic systems; or halo such as chloro, fluoro; or atoms necessary to complete a fused aromatic ring; and
L is a linkage unit consisting of alkyl, aryl, substituted alkyl, or substituted aryl, which connects the multiple benzazoles together. L may be either conjugated with the multiple benzazoles or not in conjugation with them. An example of a useful benzazole is 2,2′,2″-(1,3,5-phenylene)tris[1-phenyl-1H-benzimidazole].

Styrylarylene derivatives as described in U.S. Pat. No. 5,121,029 and JP 08333569 are also useful hosts for blue emission. For example, 9,10-bis[4-(2,2-diphenylethenyl)phenyl]anthracene and 4,4′-bis(2,2-diphenylethenyl)-1,1′-biphenyl (DPVBi) are useful hosts for blue emission.

Useful fluorescent emitting materials include, but are not limited to, derivatives of anthracene, tetracene, xanthene, perylene, rubrene, coumarin, rhodamine, and quinacridone, dicyanomethylenepyran compounds, thiopyran compounds, polymethine compounds, pyrylium and thiapyrylium compounds, fluorene derivatives, periflanthene derivatives, indenoperylene derivatives, bis(azinyl)amine boron compounds, bis(azinyl)methane compounds, and carbostyryl compounds. Illustrative examples of useful materials include, but are not limited to, the following:

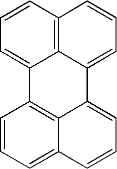

L1

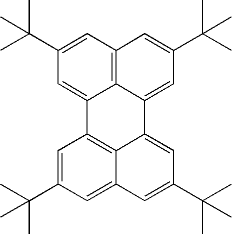

L2

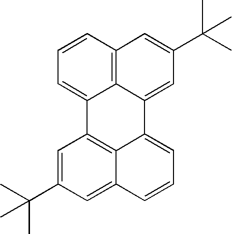

L3

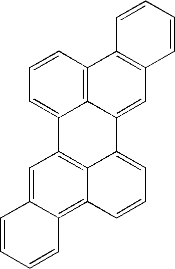

L4

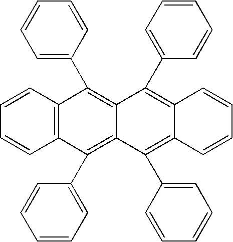

L5

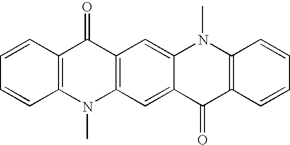

L6

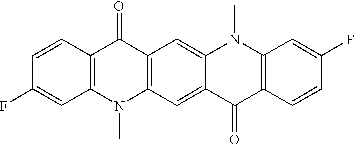

L7

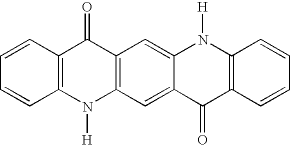

L8

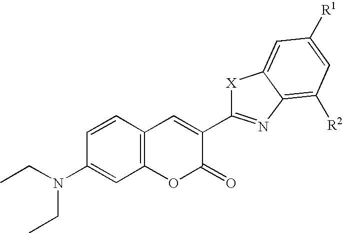

| | X | R1 | R2 |
|---|---|---|---|
| L9 | O | H | H |
| L10 | O | H | Methyl |
| L11 | O | Methyl | H |
| L12 | O | Methyl | Methyl |
| L13 | O | H | t-butyl |
| L14 | O | t-butyl | H |
| L15 | O | t-butyl | t-butyl |
| L16 | S | H | H |
| L17 | S | H | Methyl |
| L18 | S | Methyl | H |
| L19 | S | Methyl | Methyl |
| L20 | S | H | t-butyl |
| L21 | S | t-butyl | H |
| L22 | S | t-butyl | t-butyl |

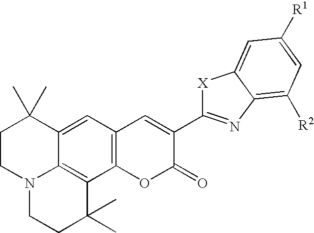

| | X | R1 | R2 |
|---|---|---|---|
| L23 | O | H | H |
| L24 | O | H | Methyl |
| L25 | O | Methyl | H |
| L26 | O | Methyl | Methyl |
| L27 | O | H | t-butyi |
| L28 | O | t-butyl | H |
| L29 | O | t-butyl | t-butyl |
| L30 | S | H | H |
| L31 | S | H | Methyl |
| L32 | S | Methyl | H |
| L33 | S | Methyl | Methyl |
| L34 | S | H | t-butyl |
| L35 | S | t-butyl | H |
| L36 | S | t-butyl | t-butyl |

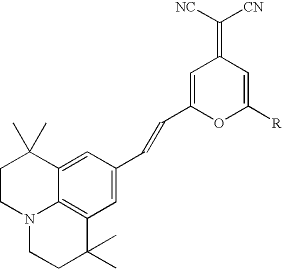

| | R |
|---|---|
| L37 | phenyl |
| L38 | methyl |
| L39 | t-butyl |
| L40 | mesityl |

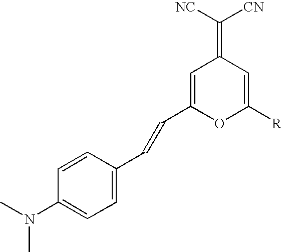

| | R |
|---|---|
| L41 | phenyl |
| L42 | methyl |
| L43 | t-butyl |
| L44 | mesityl |

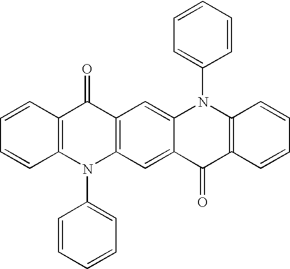

L45

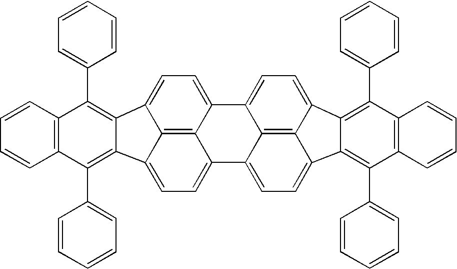

L46

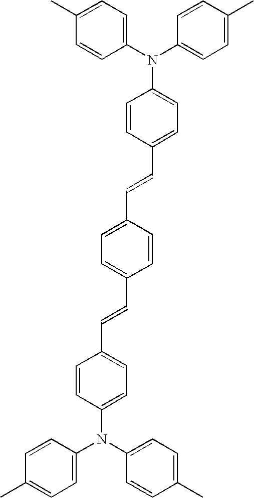

L47

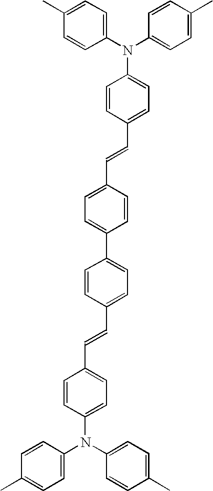

L48

In addition to fluorescent light-emitting materials, light-emitting phosphorescent materials may be used in the EL device. For convenience, the phosphorescent complex guest material may be referred to herein as a phosphorescent material. The phosphorescent material typically includes one or more ligands, for example monoanionic ligands that can be coordinated to a metal through an sp² carbon and a heteroatom. Conveniently, the ligand can be phenylpyridine (ppy) or derivatives or analogs thereof. Examples of some useful phosphorescent organometallic materials include tris(2-phenylpyridinato-N,C^{2′})iridium(III), bis(2-phenylpyridinato-N,C²)iridium(III)(acetylacetonate), and bis(2-phenylpyridinato-N,C^{2′})platinum(II). Usefully, many phosphorescent organometallic materials emit in the green region of the spectrum, that is, with a maximum emission in the range of 510 to 570 nm.

Phosphorescent materials may be used singly or in combinations other phosphorescent materials, either in the same or different layers. Phosphorescent materials and suitable hosts are described in WO 00/57676, WO 00/70655, WO 01/41512 A1, WO 02/15645 A1, U.S. 2003/0017361 A1, WO 01/93642 A1, WO 01/39234 A2, U.S. Pat. No. 6,458,475 B1, WO 02/071813 A1, U.S. Pat. No. 6,573,651 B2, U.S. 2002/0197511 A1, WO 02/074015 A2, U.S. Pat. No. 6,451,455 B1, U.S. 2003/0072964 A1, U.S. 2003/0068528 A1, U.S. Pat. No. 6,413,656 B1, U.S. Pat. No. 6,515,298 B2, U.S. Pat. No. 6,451,415 B1, U.S. Pat. No. 6,097,147, U.S. 2003/0124381 A1, U.S. 2003/0059646 A1, U.S. 2003/0054198 A1, EP 1 239 526 A2, EP 1 238 981 A2, EP 1 244 155 A2, U.S. 2002/0100906 A1, U.S. 2003/0068526 A1, U.S. 2003/0068535 A1, JP 2003073387A, JP 2003 073388A, U.S. 2003/0141809 A1, U.S. 2003/0040627 A1, JP 2003059667A, JP 2003073665A, and U.S. 2002/0121638 A1.

The emission wavelengths of cyclometallated Ir(III) complexes of the type IrL₃ and IrL₂L′, such as the green-emitting fac-tris(2-phenylpyridinato-N,C^{2′})iridium(III) and bis(2-phenylpyridinato-N,C^{2′})iridium(III)(acetylacetonate) may be shifted by substitution of electron donating or withdrawing groups at appropriate positions on the cyclometallating ligand L, or by choice of different heterocycles for the cyclometallating ligand L. The emission wavelengths may also be shifted by choice of the ancillary ligand L′. Examples of red emitters are the bis(2-(2′-benzothienyl)pyridinato-N,C^{3′})iridium(III)(acetylacetonate) and tris(2-phenylisoquinolinato-N,C)iridium(III). A blue-emitting example is bis(2-(4,6-difluorophenyl)-pyridinato-N,C^{2′})iridium(III)(picolinate).

Red electrophosphorescence has been reported, using bis(2-(2′-benzo[4,5-a]thienyl)pyridinato-N,C³) iridium (acetylacetonate) [Btp₂Ir(acac)] as the phosphorescent material (C. Adachi, S. Lamansky, M. A. Baldo, R. C. Kwong, M. E. Thompson, and S. R. Forrest, App. Phys. Lett., 78, 1622-1624 (2001)).

Other important phosphorescent materials include cyclometallated Pt(II) complexes such as cis-bis(2-phenylpyridinato-N,C^{2′})platinum(II), cis-bis(2-(2′-thienyl)pyridinato-N,C^{3′}) platinum(II), cis-bis(2-(2′-thienyl)quinolinato-N,C^{5′}) platinum(II), or (2-(4,6-difluorophenyl)pyridinato-N,C²′) platinum (II) (acetylacetonate). Pt (II) porphyrin complexes such as 2,3,7,8,12,13,17,18-octaethyl-21H, 23H-porphine platinum(II) are also useful phosphorescent materials.

Still other examples of useful phosphorescent materials include coordination complexes of the trivalent lanthanides such as Tb³⁺ and Eu³⁺ (J. Kido et al., Appl. Phys. Lett., 65, 2124 (1994)).

Suitable host materials for phosphorescent materials should be selected so that transfer of a triplet exciton can occur efficiently from the host material to the phosphorescent material but cannot occur efficiently from the phosphorescent material to the host material. Therefore, it is highly desirable that the triplet energy of the phosphorescent material be lower than the triplet energy of the host. Generally speaking, a large triplet energy implies a large optical bandgap. However, the band gap of the host should not be chosen so large as to cause an unacceptable barrier to injection of charge carriers into the light-emitting layer and an unacceptable increase in the drive voltage of the OLED. Suitable host materials are described in WO 00/70655 A2; 01/39234 A2; 01/93642 A1; 02/074015 A2; 02/15645 A1, and U.S. 20020117662. Suitable hosts include certain aryl amines, triazoles, indoles and carbazole compounds. Examples of desirable hosts are 4,4′-N,N′-dicarbazole-biphenyl, otherwise known as 4,4′-bis(carbazol-9-yl)biphenyl or CBP; 4,4′-N,N′-dicarbazole-2,2′-dimethyl-biphenyl, otherwise known as 2,2′-dimethyl-4,4′-bis(carbazol-9-yl)biphenyl or CDBP; 1,3-bis(N,N′-dicarbazole)benzene, otherwise known as 1,3-bis(carbazol-9-yl)benzene, and poly(N-vinylcarbazole), including their derivatives.

Desirable host materials are capable of forming a continuous film.

Hole-Blocking Layer (HBL)

In addition to suitable hosts, an OLED device employing a phosphorescent material often requires at least one hole-blocking layer placed between the electron-transporting layer 111 and the light-emitting layer 109 to help confine the excitons and recombination events to the light-emitting layer comprising the host and phosphorescent material. In this case, there should be an energy barrier for hole migration from the host into the hole-blocking layer, while electrons should pass readily from the hole-blocking layer into the light-emitting layer comprising a host and a phosphorescent material. The first requirement entails that the ionization potential of the hole-blocking layer be larger than that of the light-emitting layer 109, desirably by 0.2 eV or more. The second requirement entails that the electron affinity of the hole-blocking layer not greatly exceed that of the light-emitting layer 109, and desirably be either less than that of light-emitting layer or not exceed that of the light-emitting layer by more than about 0.2 eV.

When used with an electron-transporting layer whose characteristic luminescence is green, such as an Alq-containing electron-transporting layer as described below, the requirements concerning the energies of the highest occupied molecular orbital (HOMO) and lowest unoccupied molecular orbital (LUMO) of the material of the hole-blocking layer frequently result in a characteristic luminescence of the hole-blocking layer at shorter wavelengths than that of the electron-transporting layer, such as blue, violet, or ultraviolet luminescence. Thus, it is desirable that the characteristic luminescence of the material of a hole-blocking layer be blue, violet, or ultraviolet. It is further desirable, but not absolutely required, that the triplet energy of the hole-blocking material be greater than that of the phosphorescent material. Suitable hole-blocking materials are described in WO 00/70655A2 and WO 01/93642 A1. Two examples of useful hole-blocking materials are bathocuproine (BCP) and bis(2-methyl-8-quinolinolato)(4-phenylphenolato)aluminum(III) (BAlq). The characteristic luminescence of BCP is in the ultraviolet, and that of BAlq is blue. Metal complexes other than BAlq are also known to block holes and excitons as described in U.S. 20030068528. In addition, U.S. 20030175553 A1 describes the use of fac-tris(1-phenylpyrazolato-N,C^{2′})iridium(III) (Irppz) for this purpose.

When a hole-blocking layer is used, its thickness can be between 2 and 100 nm and suitably between 5 and 10 nm.

Electron-Transporting Layer (ETL)

Desirable thin film-forming materials for use in forming the electron-transporting layer 111 of the organic EL devices of this invention are metal-chelated oxinoid compounds, including chelates of oxine itself (also commonly referred to as 8-quinolinol or 8-hydroxyquinoline). Such compounds help to inject and transport electrons, exhibit high levels of performance, and are readily fabricated in the form of thin films. Exemplary of contemplated oxinoid compounds are those satisfying structural formula (E), previously described.

Other electron-transporting materials suitable for use in the electron-transporting layer 111 include various butadiene derivatives as disclosed in U.S. Pat. No. 4,356,429 and various heterocyclic optical brighteners as described in U.S. Pat. No. 4,539,507. Benzazoles satisfying structural formula (G) are also useful electron transporting materials. Triazines are also known to be useful as electron transporting materials.

If both a hole-blocking layer and an electron-transporting layer 111 are used, electrons should pass readily from the electron-transporting layer 111 into the hole-blocking layer. Therefore, the electron affinity of the electron-transporting layer 111 should not greatly exceed that of the hole-blocking layer. Desirably, the electron affinity of the electron-transporting layer should be less than that of the hole-blocking layer or not exceed it by more than about 0.2 eV.

If an electron-transporting layer is used, its thickness may be between 2 and 100 nm and suitably between 5 and 20 nm.

Other Useful Organic Layers and Device Architecture

In some instances, layers 109 through 111 can optionally be collapsed into a single layer that serves the function of supporting both light emission and electron transportation. The hole-blocking layer, when present, and layer 111 may also be collapsed into a single layer that functions to block holes or excitons, and supports electron transport. It also known in the art that emitting materials may be included in the hole-transporting layer 107. In that case, the hole-transporting material may serve as a host. Multiple materials may be added to one or more layers in order to create a white-emitting OLED, for example, by combining blue- and yellow-emitting materials, cyan- and red-emitting materials, or red-, green-, and blue-emitting materials. White-emitting devices are described, for example, in EP 1 187 235, U.S. 20020025419, EP 1 182 244, U.S. Pat. No. 5,683,823, U.S. Pat. No. 5,503,910, U.S. Pat. No. 5,405,709, and U.S. Pat. No. 5,283,182 and can be equipped with a suitable filter arrangement to produce a color emission.

This invention may be used in so-called stacked device architecture, for example, as taught in U.S. Pat. No. 5,703,436 and U.S. Pat. No. 6,337,492.

Deposition of Organic Layers

The organic materials mentioned above are suitably deposited by any means suitable for the form of the organic materials. In the case of small molecules, they are conveniently deposited through sublimation or evaporation, but can be deposited by other means such as coating from a solvent together with an optional binder to improve film formation. If the material is a polymer, solvent deposition is usually preferred. The material to be deposited by sublimation or evaporation can be vaporized from a sublimator “boat” often comprised of a tantalum material, e.g., as described in U.S. Pat. No. 6,237,529, or can be first coated onto a donor sheet and then sublimed in closer proximity to the substrate. Layers with a mixture of materials can utilize separate sublimator boats or the materials can be pre-mixed and coated from a single boat or donor sheet. Patterned deposition can be achieved using shadow masks, integral shadow masks (U.S. Pat. No. 5,294,870), spatially-defined thermal dye transfer from a donor sheet (U.S. Pat. No. 5,688,551, U.S. Pat. No. 5,851,709 and U.S. Pat. No. 6,066,357) or an inkjet method (U.S. Pat. No. 6,066,357).

Encapsulation

Most OLED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOₓ, Teflon, and alternating inorganic/polymeric layers are known in the art for encapsulation. Any of these methods of sealing or encapsulation and desiccation can be used with the EL devices constructed according to the present invention.

Optical Optimization

OLED devices of this invention can employ various well-known optical effects in order to enhance their emissive properties if desired. This includes optimizing layer thicknesses to yield maximum light transmission, providing dielectric mirror structures, replacing reflective electrodes with light-absorbing electrodes, providing anti-glare or anti-reflection coatings over the display, providing a polarizing medium over the display, or providing colored, neutral density, or color-conversion filters over the display. Filters, polarizers, and anti-glare or anti-reflection coatings may be specifically provided over the EL device or as part of the EL device.

It is contemplated that embodiments of the invention may include device structures of multiple yellow, orange, or red light-emitting layers situated above or below multiple blue or blue-green light-emitting layers as long as one yellow, orange, or red emitting layer is adjacent to one blue or blue-green light emitting layer. The light-emitting layers may be sequential, for example yellow-yellow-blue-blue, or may be alternating, for example, yellow-blue-yellow-blue, in the device. It is further contemplated that at least one yellow, orange, or red light-emitting layer will be closer to the anode than the cathode, and that at least one blue or blue-green light-emitting layer will be closer to the cathode than to the anode.

Embodiments of the invention may provide advantageous features such as higher luminous yield, lower drive voltage, higher power efficiency, improved stability, ease of manufacture, and reduced sublimation temperatures as well as desirable hues including those useful in the emission of white light (directly or through filters to provide multicolor displays). Embodiments of the invention can also provide devices incorporating the EL device such as electronic displays and an area lighting devices.

The invention and its advantages can be better appreciated by the following examples.

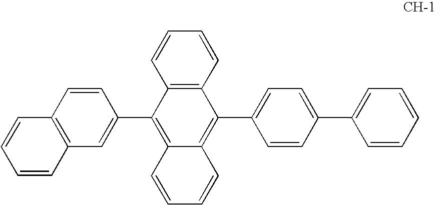

### DEVICE EXAMPLE 1

### EL Device Fabrication of Samples 1-6

An EL device (Sample 1) satisfying the requirements of the invention was constructed in the following manner:
1. A glass substrate coated with an 85 nm layer of indium-tin oxide (ITO) as the anode was sequentially ultrasonicated in a commercial detergent, rinsed in deionized water, degreased in toluene vapor and exposed to oxygen plasma for about 1 min.
2. Over the ITO was deposited a 1 nm fluorocarbon (CFx) hole-injecting layer (HIL) by plasma-assisted deposition of CHF₃.
3. A hole-transporting layer (HTL) of N,N′-di-1-naphthyl-N,N-diphenyl-4,4′-diaminobiphenyl (NPB) having a thickness of 130 nm was then evaporated from a tantalum boat.
4. A 20 nm light-emitting layer (LEL), including host material NPB, and light-emitting material L54 (2.50 vol %), was then deposited onto the hole-transporting layer. These materials were also evaporated from tantalum boats.
5. A 40 nm light-emitting layer (LEL), including host material Inv-1 and light-emitting material TBP (2,5,8,11-tetra-t-butylperylene), was then deposited onto the hole-transporting layer. These materials were also evaporated from tantalum boats.
6. A 15 nm electron-transporting layer (ETL) of tris(8-quinolinolato)aluminum (III) (AlQ₃) was then deposited onto the light-emitting layer. This material was also evaporated from a tantalum boat.
7. On top of the AlQ₃ layer was deposited a 220 nm cathode formed of a 10:1 volume ratio of Mg and Ag.

The above sequence completed the deposition of the EL device. The device was then hermetically packaged in a dry glove box for protection against ambient environment.

EL devices, Samples 1-3, incorporating host material Inv-1 were fabricated as described above and the level of TBP (2,5,8,11-tetrabutylperylene) are indicated in Table 1. Comparison Samples 4-6 were prepared in the same manner as Samples 1-3 except Inv-1 was replaced with TBADN, (2-t-butyl-9,10-di-(2-naphthyl)anthracene).

The devices thus formed were tested for efficiency and color at an operating current of 20 mA/cm² and the results are reported in Table 1 in the form of output efficiency (W/A), luminance yield (cd/A), and CIE (Commission Internationale de L'Eclairage) coordinates. The devices were tested for stability by operating the cells at 20 mA/cm² for 200 h at 70° C. The luminance after operating for this time relative to the initial luminance is listed in Table 1 as a percentage.

TABLE 1
Evaluation Results for EL devices 1-6.

| | | | TBP | | | | | |
|---|---|---|---|---|---|---|---|---|
| | | Efficiency | Level | Yield | | | 200 h | |
| Sample | Host | (W/A) | (vol %) | (cd/A) | CIEx | CIEy | Stability | Type |
| 1 | Inv-1 | 0.035 | 1.00 | 3.70 | 0.346 | 0.369 | 92% | Invention |
| 2 | Inv-1 | 0.033 | 2.00 | 3.65 | 0.352 | 0.378 | 94% | Invention |
| 3 | Inv-1 | 0.031 | 3.00 | 3.45 | 0.367 | 0.391 | 93% | Invention |
| 4 | TBADN | 0.039 | 1.00 | 3.69 | 0.309 | 0.318 | 76% | Comparison |
| 5 | TBADN | 0.039 | 2.00 | 3.96 | 0.350 | 0.353 | 76% | Comparison |
| 6 | TBADN | 0.036 | 3.00 | 3.71 | 0.346 | 0.360 | 82% | Comparison |

It can be seen from Table 1 that Inv-1 in combination with TBP affords a high luminance yield at good operating efficiency and improved operating stability relative to a comparison device with TBADN when the two are compared at similar levels of light-emitting material. The Inv-1/TBP combination affords a color that is more desirable for use in a white light-emitting device than the TBADN/TBP combination.

### DEVICE EXAMPLE 2

### EL Device Fabrication of Samples 7-12

EL devices, Samples 7-9, were fabricated in an identical manner as Samples 1-3, except TBP was replaced with light-emitting material L47, and the levels of L47 are indicated in Table 2. Comparison Samples 10-12 were prepared in the same manner as Samples 7-9 except host material Inv-1 was replaced by TBADN. The devices thus formed were tested in the same manner as Samples 1-6. The testing results are reported in Table 2.

TABLE 2
Evaluation Results for EL devices 7-12.

| | | | L47 | | | | | |
|---|---|---|---|---|---|---|---|---|
| | | Efficiency | Level | Yield | | | 200 h | |
| Sample | Host | (W/A) | (vol %) | (cd/A) | CIEx | CIEy | Stability | Type |
| 7 | Inv-1 | 0.068 | 2.00 | 8.26 | 0.354 | 0.449 | 90% | Invention |
| 8 | Inv-1 | 0.074 | 2.50 | 8.99 | 0.349 | 0.459 | 89% | Invention |
| 9 | Inv-1 | 0.070 | 3.00 | 8.65 | 0.342 | 0.469 | 87% | Invention |
| 10 | TBADN | 0.072 | 2.00 | 7.47 | 0.312 | 0.378 | 80% | Comparison |
| 11 | TBADN | 0.079 | 2.50 | 8.52 | 0.307 | 0.400 | 78% | Comparison |
| 12 | TBADN | 0.081 | 3.00 | 8.80 | 0.304 | 0.409 | 82% | Comparison |

It can be seen from Table 2 that Inv-1 in combination with L47 affords a good luminance yield at good operating efficiency and improved operating stability relative to a comparison device when the two devices are compared at similar levels of light-emitting material. The Inv-1/L47 combination affords a color that is more desirable for use in a white light-emitting device than the TBADN/L47 combination.

### DEVICE EXAMPLE 3

### EL Device Fabrication of Samples 13-18

EL devices, Samples 13-15, were fabricated in an identical manner as Samples 1-3, except TBP was replaced with light-emitting material L53, and the level of L53 are indicated in Table 3. Comparison Samples 16-18 were prepared in the same manner as Samples 13-15 except host material Inv-1 was replaced by TBADN. The devices thus formed were tested in the same manner as Samples 1-6. The testing results are reported in Table 3.

TABLE 3
Evaluation Results for EL devices 13-18.

| | | | L53 | | | | | |
|---|---|---|---|---|---|---|---|---|
| | | Efficiency | Level | Yield | | | 200 h | |
| Sample | Host | (W/A) | (vol %) | (cd/A) | CIEx | CIEy | Stability | Type |
| 13 | Inv-1 | 0.033 | 0.50 | 3.60 | 0.373 | 0.365 | 95% | Invention |
| 14 | Inv-1 | 0.029 | 0.75 | 3.19 | 0.361 | 0.362 | 95% | Invention |
| 15 | Inv-1 | 0.030 | 1.25 | 3.16 | 0.357 | 0.353 | 98% | Invention |
| 16 | TBADN | 0.037 | 0.50 | 3.07 | 0.302 | 0.267 | 86% | Comparison |
| 17 | TBADN | 0.037 | 0.75 | 2.97 | 0.288 | 0.259 | 87% | Comparison |
| 18 | TBADN | 0.034 | 1.25 | 2.64 | 0.269 | 0.249 | 90% | Comparison |

It can be seen from Table 3 that Inv-1 in combination with L53 affords a good luminance yield at good operating efficiency and improved operating stability relative to a comparison device when the two devices are compared at similar levels of light-emitting material. The Inv-1/L53 combination affords a color that is more desirable for use in a white light-emitting device than the TBADN/L53 combination.

### DEVICE EXAMPLE 4

### EL Device Fabrication of Samples 19-24

EL devices, Samples 19-21, were fabricated in an identical manner as Samples 13-15. Comparison Samples 22-25 were prepared in the same manner as Samples 19-21 except host material Inv-1 was replaced by host material CH-1. The devices thus formed were tested in the same manner as Samples 1-6. The testing results are reported in Table 4.

TABLE 4
Evaluation Results for EL devices 19-24.

| | | | L53 | | | | | |
|---|---|---|---|---|---|---|---|---|
| | | Efficiency | Level | Yield | | | 200 h | |
| Sample | Host | (W/A) | (vol %) | (cd/A) | CIEx | CIEy | Stability | Type |
| 19 | Inv-1 | 0.030 | 0.50 | 3.29 | 0.358 | 0.370 | 91% | Invention |
| 20 | Inv-1 | 0.030 | 0.75 | 3.16 | 0.346 | 0.351 | 91% | Invention |
| 21 | Inv-1 | 0.030 | 1.25 | 3.14 | 0.343 | 0.350 | 91% | Invention |
| 22 | CH-1 | 0.045 | 0.50 | 4.30 | 0.339 | 0.314 | 91% | Comparison |
| 23 | CH-1 | 0.043 | 0.75 | 4.16 | 0.326 | 0.310 | 91% | Comparison |
| 24 | CH-1 | 0.041 | 1.25 | 3.95 | 0.323 | 0.311 | 87% | Comparison |

It can be seen from Table 4 that Inv-1 in combination with L53 affords a good luminance yield at good operating efficiency and operating stability relative to a comparison device when the two devices are compared at similar levels of light-emitting material. The Inv-1/L53 combination affords a color that is more desirable for use in a white light-emitting device than the CH-1/L53 combination.

### DEVICE EXAMPLE 5

### EL Device Fabrication of Samples 25-30

EL devices, Samples 25-27, were fabricated in an identical manner as Sample 1-3, except light-emitting material L54 was replaced with light-emitting material L55. Comparison Samples 28-30 were prepared in the same manner as Samples 25-27 except host material Inv-1 was replaced by host material CH-1. The devices thus formed were tested in the same manner as Samples 1-6 except the devices were operated at 20 mA/cm² for 100 h at 70° C. The testing results are reported in Table 5.

TABLE 5
Evaluation Results for EL devices 25-30.

| | | | TBP | | | | | |
|---|---|---|---|---|---|---|---|---|
| | | Efficiency | Level | Yield | | | 100 h | |
| Sample | Host | (W/A) | (vol %) | (cd/A) | CIEx | CIEy | Stability | Type |
| 25 | Inv-1 | 0.034 | 0.50 | 3.12 | 0.284 | 0.310 | 96% | Invention |
| 26 | Inv-1 | 0.035 | 1.00 | 3.24 | 0.280 | 0.315 | 95% | Invention |
| 27 | Inv-1 | 0.034 | 2.00 | 3.07 | 0.282 | 0.315 | 98% | Invention |
| 28 | CH-1 | 0.046 | 0.50 | 3.91 | 0.274 | 0.285 | 95% | Comparison |
| 29 | CH-1 | 0.045 | 1.00 | 3.84 | 0.274 | 0.289 | 95% | Comparison |
| 30 | CH-1 | 0.044 | 2.00 | 3.92 | 0.279 | 0.303 | 93% | Comparison |

It can be seen from Table 5 that the device of the invention tested affords a good luminance yield at good operating efficiency and improved operating stability relative to a comparison device when the two devices are compared at similar levels of light-emitting material. The combination of device materials including host material Inv-1 affords a color that is more desirable for use in a white light-emitting device than the combination of device materials including host material CH-1.

The entire contents of the patents and other publications referred to in this specification are incorporated herein by reference. The invention has been described in detail with particular reference to certain preferred embodiments thereof, but it will be understood that variations and modifications can be effected within the spirit and scope of the invention.

### PARTS LIST

101 Substrate
103 Anode
105 Hole-Injecting layer (HIL)
107 Hole-Transporting layer (HTL)
109 Light-Emitting layer (LEL)
111 Electron-Transporting layer (ETL)
113 Cathode
150 Voltage/Current source
160 Electrical conductors

1. An OLED device for emitting white light comprising adjacent layers 1 and 2 wherein layer 1 contains a host and a yellow, orange, or red emitter and layer 2 contains a host and a blue or blue-green light emitter wherein the host in layer 2 comprises an anthracene material bearing an aromatic ring bonded to the 2-, 9-, and 10-positions of the anthracene nucleus.

2. The device of claim 1 wherein the layer 1 host comprises an aromatic tertiary amine, a metal-chelated oxinoid compound, an anthracene, or a benzazole compound.

3. The device of claim 1 wherein the layer 1 host comprises a tetracene, naphthacene, rubrene, quinacridone, coumarin, anthracene, fluorene, periflanthene, xanthene, rhodamine, dicyanomethylenepyran, thiopyran, pyrylium, thiapyrylium, or an indenoperylene compound.

4. A device of claim 1 wherein layer 1 host comprises an aromatic tertiary amine compound and a rubrene compound.

5. The device of claim 1 wherein the light emitter in layer 2 comprises a perylene, distyrylarene, or a boron atom containing compound.

6. The device of claim 1 wherein the anthracene host material in layer 2 comprises at least one 2-naphthyl group.

7. The device of claim 1 wherein the anthracene host material in layer 2 comprises independently selected naphthyl groups in the 9- and 10-positions.

8. The device of claim 7, wherein the naphthyl groups are independently selected 2-naphthyl groups.

9. The device of claim 7, wherein the naphthyl groups in the 9- and 10-positions are the same groups.

10. The device of claim 1 wherein the anthracene host material in layer 2 comprises a biphenyl group in the 10-position.

11. The device of claim 1, wherein the 6-position of the anthracene host material bears a hydrogen.

12. The device of claim 1, wherein the aromatic ring in the 2-position of the anthracene is a monocyclic phenyl group, a naphthyl group or a biphenyl group.

13. The device of claim 1, wherein the anthracene host material in layer 2 comprises only one anthracene moiety.

14. The device of claim 1, wherein the anthracene host material in layer 2 comprises two anthracene moieties.

15. The device of claim 1, wherein the anthracene host material is represented by Formula (1), 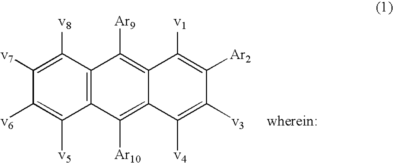
Ar₂ represents an aryl group;
Ar₉ represents a naphthyl group;
Ar₁₀ represents an aryl group; and
v₁, v₃, v₄, v₅, v₆, v₇, and v₈ independently represent hydrogen or a substituent.

16. The device of claim 15, wherein Ar₉ and Ar₁₀ represent independently selected naphthyl groups.

17. The device of claim 15, wherein Ar₁₀ represents a biphenyl group.

18. The device of claim 15, wherein Ar₂ represents a naphthyl or biphenyl group.

19. The device of claim 15, wherein Ar₂ represents a monocyclic phenyl group.

20. The device of claim 1, wherein a light-emitting layer includes a green-light emitting material.

21. The device of claim 1, wherein a light-emitting layer includes a material of Formula (2a) or (2b), 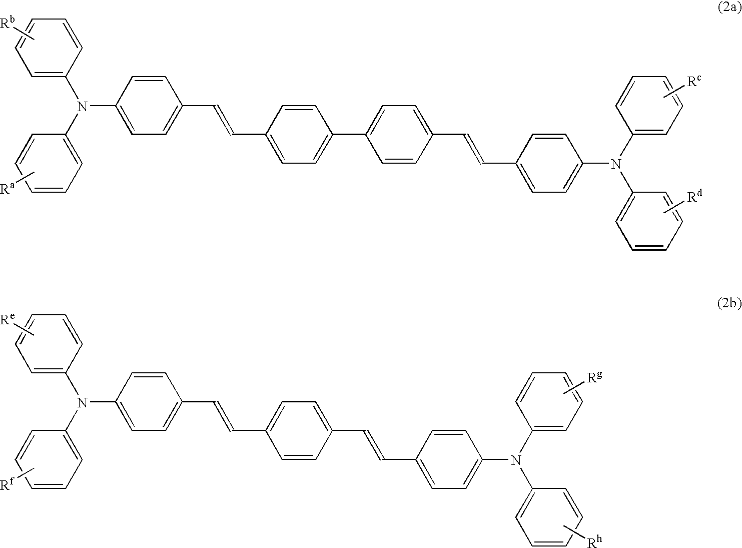
wherein:
R^{a}-R^{h} independently represent hydrogen or an independently selected substituent.

22. The device of claim 1 wherein a light-emitting layer includes a compound represented by Formula (3a), 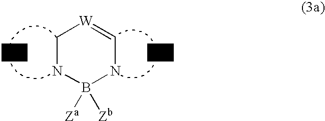
wherein:
W represents N or C—Y, wherein Y represents hydrogen or a substituent;
Ar^{a} and Ar^{b} independently represent the atoms necessary to form an aromatic ring group; and
Z^{a} and Z^{b} represent independently selected substituents.

23. The device of claim 1 wherein a light emitting layer includes a perylene compound.

24. The device of claim 23 wherein a light-emitting layer includes a compound having the nucleus:

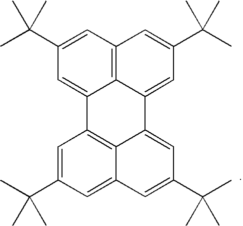

25. The device of claim 1 wherein a light-emitting layer includes a rubrene compound.

26. The device of claim 25 wherein a light-emitting layer includes

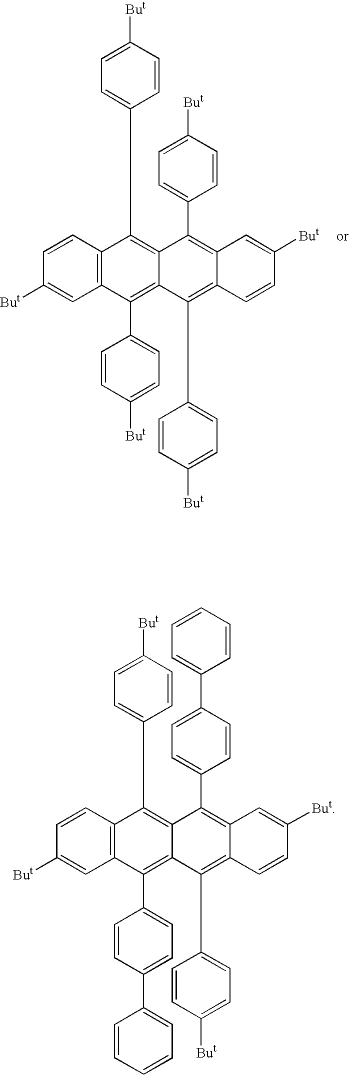

27. The device of claim 1 wherein a light emitting layer includes an indenoperylene compound.

28. The device of claim 27 wherein a light-emitting layer includes a compound having the nucleus:

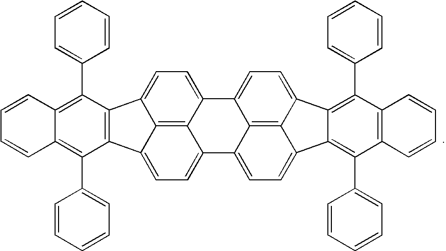

29. The device of claim 1 wherein a light-emitting layer includes a dicyanomethylenepyran compound.

30. The device of claim 29 wherein a light-emitting layer includes

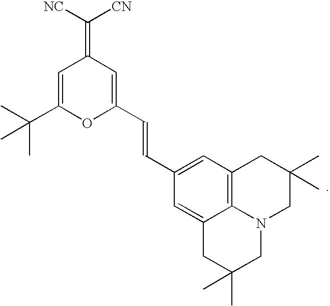

31. The device of claim 1 wherein the anthracene material is selected from the following:

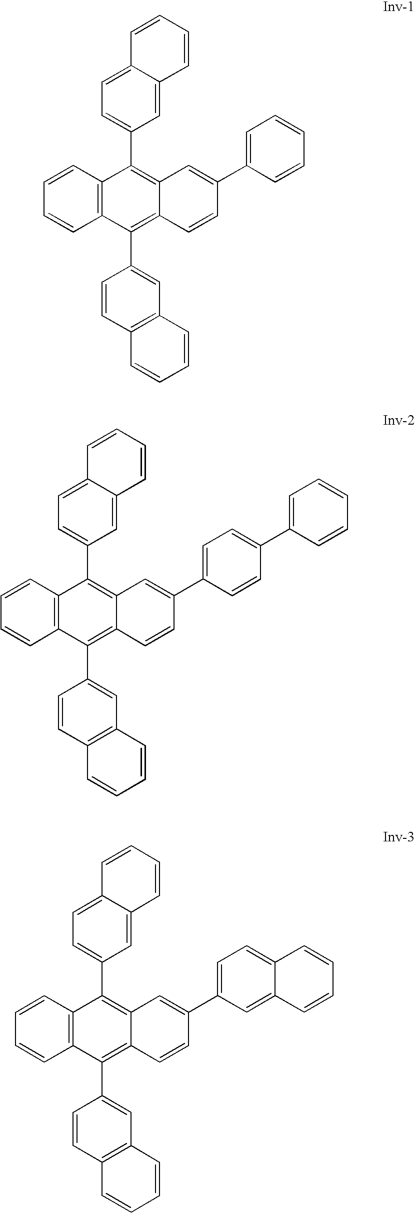

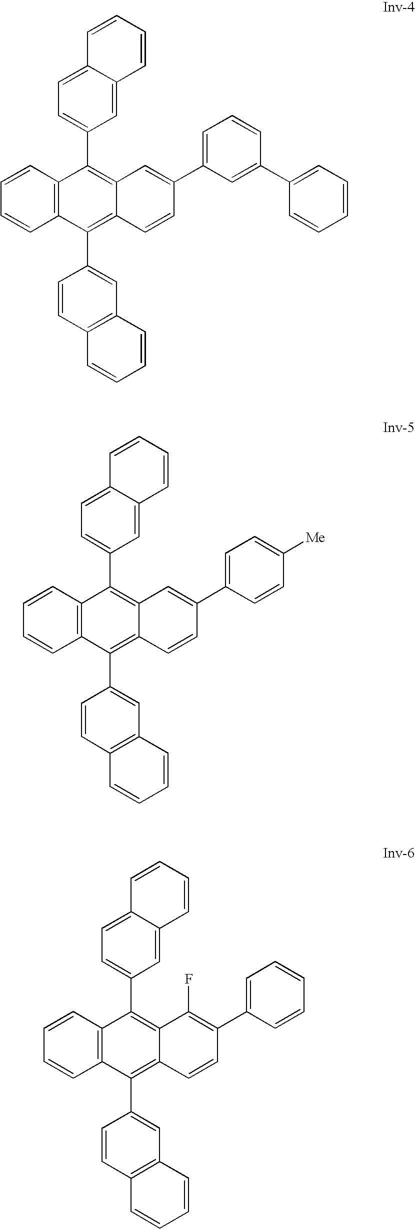

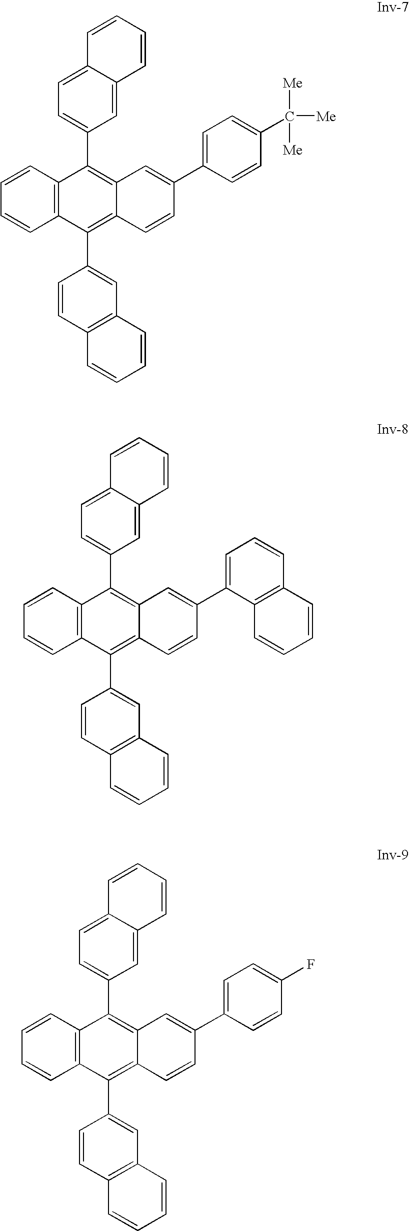

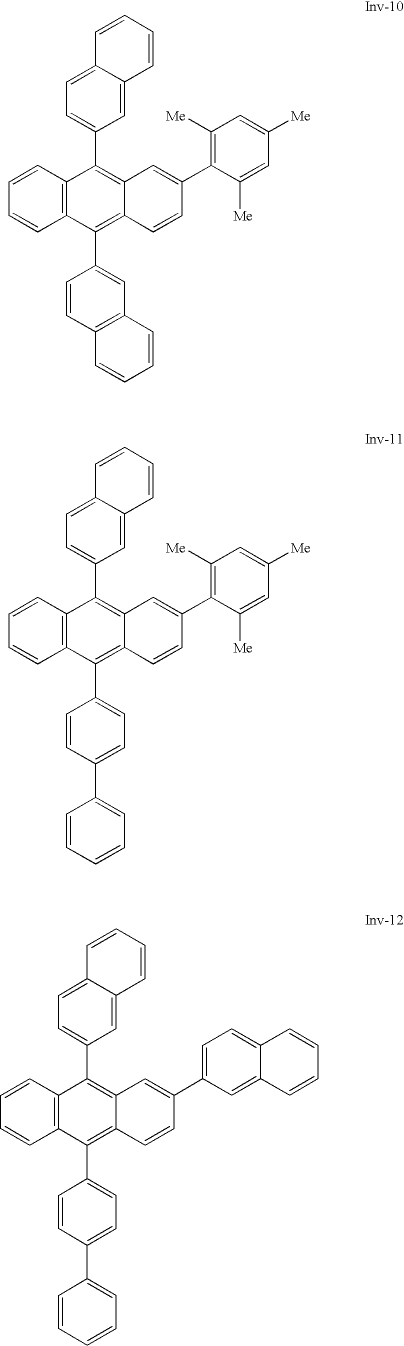

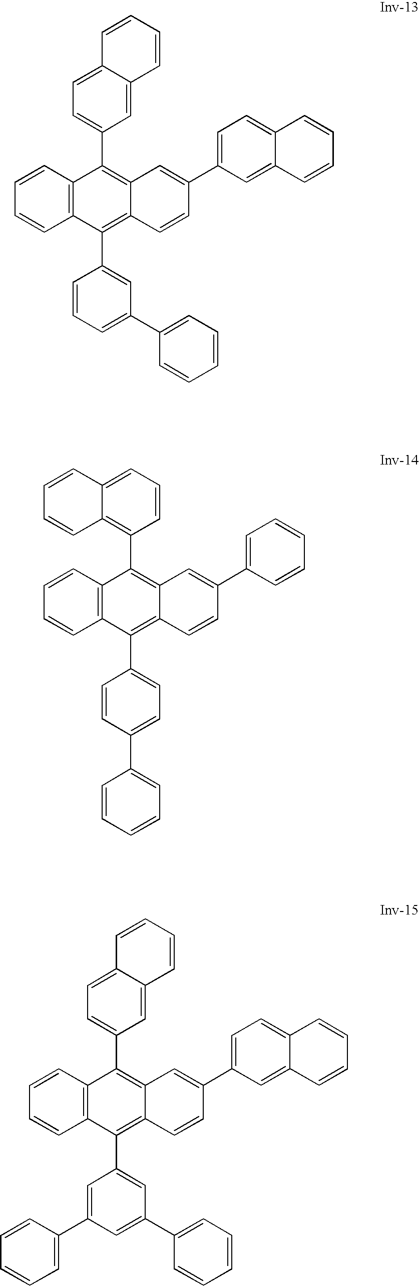

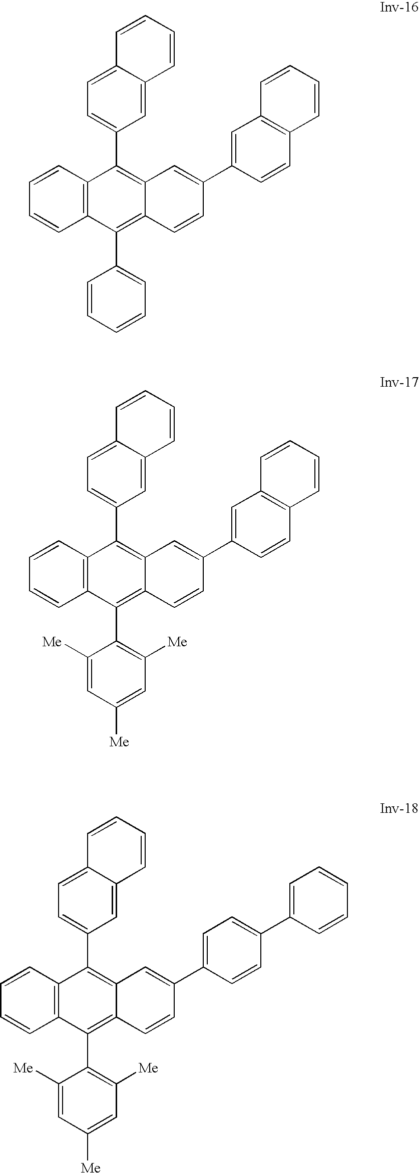

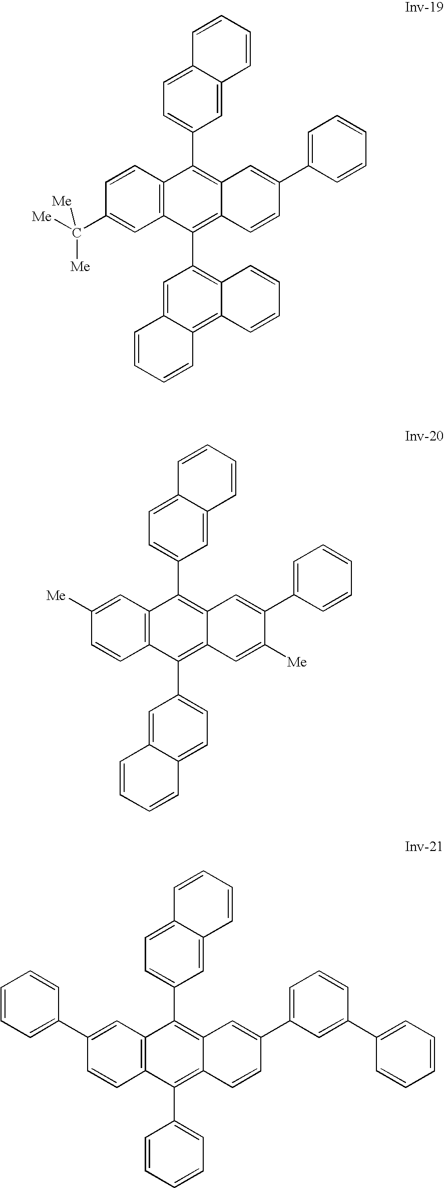

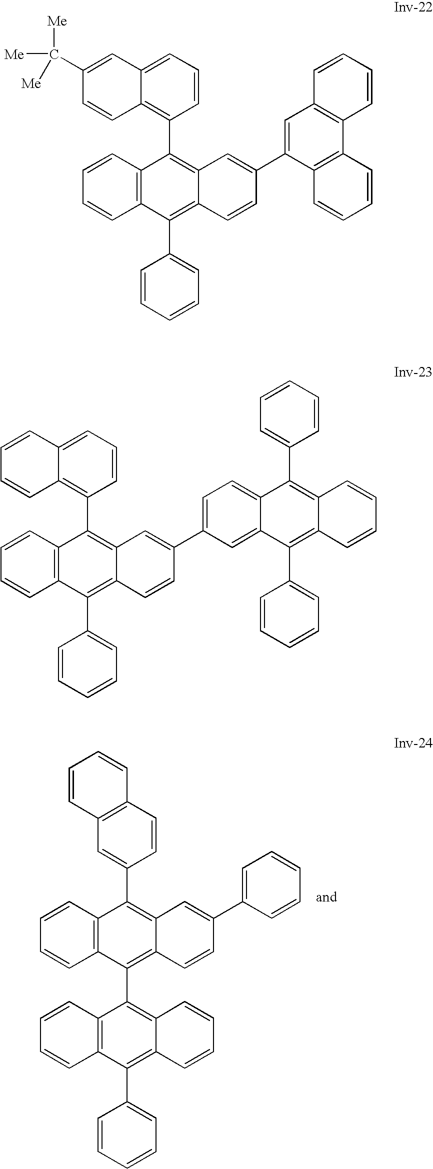

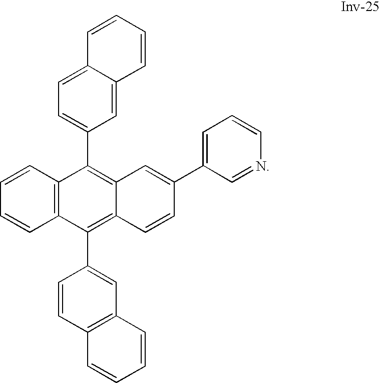

32. A device of claim 1 wherein the yellow, orange or red light-emitting materials are incorporated at 0.01 to 10% by weight of the host material.

33. A device of claim 1 wherein the yellow, orange or red light-emitting materials are incorporated at 1% to 5% by weight of the host material.

34. A device of claim 1 wherein the blue or blue-green light-emitting materials are incorporated at 0.01 to 10% by weight of the host material.

35. A device of claim 1 wherein the blue or blue-green light-emitting materials are incorporated at 0.5% to 5% by weight of the host material.

36. The device of claim 1 wherein white light is produced either directly or by using filters.

37. A display comprising the electroluminescent device of claim 1.

38. An area lighting device comprising the electroluminescent device of claim 1.

39. A process for emitting light comprising applying a potential across the device of claim 1.

40. A device of claim 1 wherein a yellow, orange or red light-emitting layer is located closer to the anode than a blue or blue-green emitting layer.

41. A device of claim 1 wherein a yellow, orange or red light-emitting layer is located closer to the cathode than a blue or blue-green emitting layer.

42. A device of claim 1 comprising at least three light emitting layers.

43. A device of claim 42 wherein two or more adjacent layers emit the same color.

44. A device of claim 42 wherein two or more layers emitting the same color are separated by a layer emitting a different color.

45. A device of claim 1 comprising a hole-transporting material in the yellow, orange, or red light-emitting layer.

46. A device of claim 1 comprising a hole-transporting material in the blue or blue-green light-emitting layer.

47. A device of claim 1 comprising an electron-transporting material in the yellow, orange, or red light-emitting layer.

48. A device of claim 1 comprising an electron-transporting material in the blue or blue-green light-emitting layer.

49. A device of claim 1 wherein the host or light-emitting materials comprise polymeric materials.

50. A device of claim 1 wherein the light-emitting materials comprise phosphorescent materials.
